(19) United States
(12) Patent Application Publication
(10) Pub. No.: US 2026/0214721 A1
(43) Pub. Date: Jul. 23, 2026

(54) METHOD AND APPARATUS FOR RANDOM ACCESS FOR DEVICE IN COMMUNICATION SYSTEM

(71) Applicant: Electronics and Telecommunications Research Institute, Daejeon (KR)

(72) Inventors: Hoiyoon JUNG, Daejeon (KR); Ji Hyung KIM, Daejeon (KR); Cheulsoon KIM, Daejeon (KR); Sung-Hyun MOON, Daejeon (KR); Junghoon LEE, Daejeon (KR)

(21) Appl. No.: 19/452,153

(22) Filed: Jan. 16, 2026

(30) Foreign Application Priority Data
Jan. 17, 2025 (KR) 10-2025-0007448
Mar. 25, 2025 (KR) 10-2025-0038343
Apr. 25, 2025 (KR) 10-2025-0054396
Jun. 24, 2025 (KR) 10-2025-0083623
Sep. 8, 2025 (KR) 10-2025-0127346
Dec. 31, 2025 (KR) 10-2025-0216569

(51) Int. Cl. H04W 74/0833; H04W 72/1263

(52) U.S. Cl. CPC H04W 74/0833; H04W 72/1263

(57) ABSTRACT

A method of a device may comprise: receiving, from a reader, a physical reader to device channel (PRDCH) including scheduling information for a first message of a random access procedure; determining a first time resource for transmission of the first message based on an end time of the PRDCH and a first time offset; and transmitting, to the reader, a physical device to reader channel (PDRCH) including the first message in the first time resource.

### CROSS-REFERENCE TO RELATED APPLICATIONS

This application claims priority to Korean Patent Applications No. 10-2025-0007448, filed on Jan. 17, 2025, No. 10-2025-0038343, filed on Mar. 25, 2025, No. 10-2025-0054396, filed on Apr. 25, 2025, No. 10-2025-0083623, filed on Jun. 24, 2025, No. 10-2025-0127346, filed on Sep. 8, 2025, and No. 10-2025-0216569, filed on Dec. 31, 2025, with the Korean Intellectual Property Office (KIPO), the entire contents of which are hereby incorporated by reference.

### BACKGROUND

### 1. Technical Field

The present disclosure relates to a random access technique in a communication system, and more particularly, to a technique for an Internet of Things (IoT) terminal to perform random access to a base station or a terminal.

### 2. Related Art

With advancements in information and communication technology, various wireless communication technologies are being developed. Representative wireless communication technologies include long term evolution (LTE), LTE-Advanced (LTE-A), new radio (NR), and the like, as specified in the 3rd Generation Partnership Project (3GPP) standards. LTE and/or LTE-A may be classified as 4th generation (4G) communication technologies, while NR may be a 5th generation (5G) communication technology.

The 5G communication system (e.g., a communication system supporting NR) operating in a higher frequency band (e.g., a frequency band of 6 GHz or above) than that of the 4G communication system (e.g., a frequency band of 6 GHz or below) has been considered to handle the soaring wireless data traffic after the commercialization of the 4G communication system (e.g., a communication system supporting LTE and/or LTE-A). The 5G communication system may support enhanced Mobile Broadband (eMBB), Ultra-Reliable Low-Latency Communication (URLLC), and/or Massive Machine-Type Communication (mMTC).

In a communication system (e.g., a 5G communication system, a 6G communication system, etc.), an Internet of Things (IoT) communication scheme may be supported to accommodate a plurality of IoT devices. The IoT devices may perform communication with a base station and/or a terminal in the communication system using the IoT communication scheme. In consideration of factors such as power consumption, the IoT devices may be configured in a form of very low complexity. In the communication system, a random access procedure may be required for an IoT device to perform communication with a base station or a terminal. In other words, a random access procedure for the IoT device, detailed operations for supporting the random access procedure, and configuration operations (e.g., resource configuration operations) for the random access procedure may be required.

Meanwhile, the above-described technologies are described to enhance the understanding of the background of the present disclosure, and they may include non-prior arts that are not already known to those of ordinary skill in the art.

### SUMMARY

The present disclosure for resolving the above-described problems is directed to providing a method and apparatus for a random access procedure of a device.

A method of a device, according to exemplary embodiments of the present disclosure, may comprise: receiving, from a reader, a physical reader to device channel (PRDCH) including scheduling information for a first message of a random access procedure; determining a first time resource for transmission of the first message based on an end time of the PRDCH and a first time offset; and transmitting, to the reader, a physical device to reader channel (PDRCH) including the first message in the first time resource.

The first time offset may be determined based on a chip length used for transmission of the PDRCH.

Based on the chip length used for transmission of the PDRCH being equal to or greater than a threshold, the first time offset may be determined as a large value among a plurality of values.

Based on the chip length used for transmission of the PDRCH being less than a threshold, the first time offset may be determined as a small value among a plurality of values.

The first time offset may be determined based on a chip length used for transmission of the PRDCH including the scheduling information for the first message.

Based on the chip length used for transmission of the PRDCH being equal to or greater than a threshold, the first time offset may be determined as a large value among a plurality of values.

Based on the chip length used for transmission of the PRDCH being less than a threshold, the first time offset may be determined as a small value among a plurality of values.

The PRDCH may be a random access indication indicating initiation of the random access procedure.

A method of a device, according to exemplary embodiments of the present disclosure, may comprise: receiving, from a reader, a physical reader to device channel (PRDCH) including scheduling information for a first message of a random access procedure; determining, based on an end time of the PRDCH and a second time offset, a second time resource after a first time resource among a plurality of resources for transmission of the first message; and transmitting, to the reader, a second physical device to reader channel (PDRCH) including the first message in the second time resource.

The second time offset may be determined based on a first time offset used to determine the first time resource and a length of a first PDRCH transmitted in the first time resource.

The second time offset may be determined by multiplying a sum of the first time offset and the length of the first PDRCH with a constant value including a length of a time buffer.

The length of the first PDRCH transmitted in the first time resource may be determined based on a product of a number of chips transmitted through the first PDRCH and a chip length used for transmission of the first PDRCH.

The PRDCH may be a random access indication indicating initiation of the random access procedure.

A device, according to exemplary embodiments of the present disclosure, may comprise at least one processor, wherein the at least one processor may cause the device to perform: receiving, from a reader, a physical reader to device channel (PRDCH) including scheduling information for a first message of a random access procedure; determining a first time resource for transmission of the first message based on an end time of the PRDCH and a first time offset; and transmitting, to the reader, a physical device to reader channel (PDRCH) including the first message in the first time resource.

The first time offset may be determined based on a chip length used for transmission of the PDRCH.

Based on the chip length used for transmission of the PDRCH being equal to or greater than a threshold, the first time offset may be determined as a large value among a plurality of values.

Based on the chip length used for transmission of the PDRCH being less than a threshold, the first time offset may be determined as a small value among a plurality of values.

The first time offset may be determined based on a chip length used for transmission of the PRDCH including the scheduling information for the first message.

Based on the chip length used for transmission of the PRDCH being equal to or greater than a threshold, the first time offset may be determined as a large value among a plurality of values.

Based on the chip length used for transmission of the PRDCH being less than a threshold, the first time offset may be determined as a small value among a plurality of values.

According to the present disclosure, a device can determine a position of a time resource for Msg1 transmission in a random access procedure and can perform Msg1 transmission in the determined time resource. The position of the time resource can be determined based on an end time of a physical reader to device channel (PRDCH) scheduling Msg1 transmission and a time offset. A reader can also determine the position of the time resource in which Msg1 transmission is performed based on the above-described scheme. Ambiguity regarding the time resource in which Msg1 transmission is performed does not occur between the device and the reader, and accordingly, the random access procedure can be performed without problems. Therefore, performance of a communication system may be improved.

### BRIEF DESCRIPTION OF DRAWINGS

FIG. 1 is a conceptual diagram illustrating a communication network.

FIG. 2 is a block diagram illustrating a communication node constituting a communication network.

FIG. 3 is a conceptual diagram illustrating a communication network.

FIG. 4 is a conceptual diagram illustrating a communication network.

FIG. 5 is a conceptual diagram illustrating a structure of a D2R signal in a communication network.

FIG. 6 is a conceptual diagram illustrating a structure of a D2R signal in a communication network.

FIG. 7 is a conceptual diagram illustrating exemplary embodiments of line codes in a communication network.

FIG. 8 is a conceptual diagram illustrating exemplary embodiments of line codes in a communication network.

FIG. 9 is a conceptual diagram illustrating a PDRCH scheduling method.

FIG. 10 is a conceptual diagram illustrating a PDRCH scheduling method.

FIG. 11 is a conceptual diagram illustrating a PRDCH configuration in a communication network.

FIG. 12 is a sequence diagram illustrating a random access procedure of a device.

FIG. 13 is a conceptual diagram illustrating a random access procedure of a device.

FIG. 14 is a conceptual diagram illustrating time resource configuration for first message transmission by a device.

FIG. 15 is a conceptual diagram illustrating time resource configuration for first message transmission by a device.

FIG. 16 is a conceptual diagram illustrating time resource configuration for first message transmission by a device.

FIG. 17 is a conceptual diagram illustrating frequency resource configuration for first message transmission by a device.

FIG. 18 is a conceptual diagram illustrating a second message monitoring duration.

FIG. 19 is a conceptual diagram illustrating a second message monitoring duration.

FIG. 20 is a conceptual diagram illustrating a second message monitoring duration.

FIG. 21 is a conceptual diagram illustrating a second message monitoring duration.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may mean “at least one of A or B” or “at least one of combinations of one or more of A and B”. Also, in exemplary embodiments of the present disclosure, “one or more of A and B” may mean “one or more of A or B” or “one or more of combinations of one or more of A and B”.

In exemplary embodiments of the present disclosure, “(re)transmission” may mean “transmission”, “retransmission”, or “transmission and retransmission”, “(re)configuration” may mean “configuration”, “reconfiguration”, or “configuration and reconfiguration”, “(re)connection” may mean “connection”, “reconnection”, or “connection and reconnection”, and “(re)access” may mean “access”, “re-access”, or “access and re-access”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, preferred exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication network to which exemplary embodiments according to the present disclosure are applied will be described. The communication network to which the exemplary embodiments according to the present disclosure are applied is not limited to the contents described below, and the exemplary embodiments according to the present disclosure may be applied to various communication networks. Here, the communication network may be used in the same sense as a communication system. A communication network may refer to a wireless communication network, and a communication system may refer to a wireless communication system.

In the present disclosure, “an operation (e.g., transmission operation) is configured” may mean that “configuration information (e.g., information element(s) or parameter(s)) for the operation and/or information indicating to perform the operation is signaled”. “Information element(s) (e.g., parameter(s)) are configured” may mean that “corresponding information element(s) are signaled”. In the present disclosure, signaling may be at least one of system information (SI) signaling (e.g., transmission of system information block (SIB) and/or master information block (MIB)), RRC signaling (e.g., transmission of RRC parameters and/or higher-layer parameters), MAC control element (CE) signaling, or PHY signaling (e.g., transmission of downlink control information (DCI), uplink control information (UCI), and/or sidelink control information (SCI)).

In the present disclosure, ‘time’ and ‘time point’ may be used interchangeably. The term ‘time’ may be interpreted as referring to either a time or a time point depending on a context, and the term ‘time point’ may also be interpreted as referring to either a time or a time point depending on a context. A start time may refer to a transmission start time or a reception start time. An end time may refer to a transmission end time or a reception end time. The transmission end time and the reception end time may be used interchangeably depending on a context.

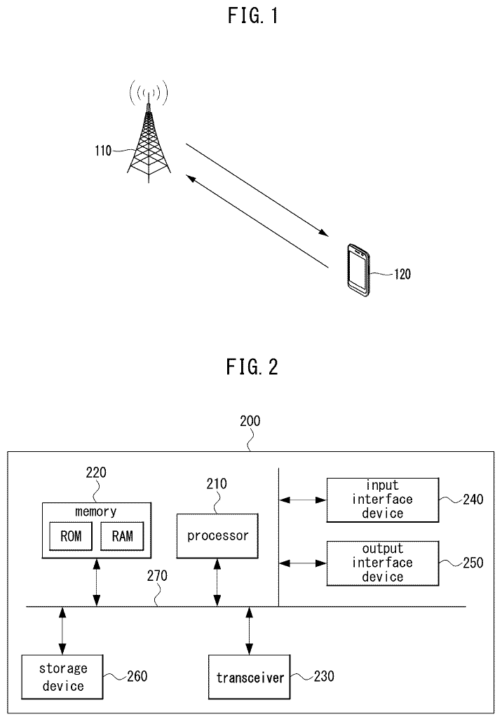

FIG. 1 is a conceptual diagram illustrating a communication network.

Referring to FIG. 1, a base station 110 may support cellular communication (e.g., long term evolution (LTE), LTE-Advanced (LTE-A), LTE-APro, LTE-unlicensed (LTE-U), New Radio (NR), and NR-unlicensed (NR-U) specified as the 3^{rd} generation partnership project (3GPP) standards), or the like. The base station 110 may support multiple-input multiple-output (MIMO) (e.g., single-user MIMO (SU-MIMO), multi-user MIMO (MU-MIMO), massive MIMO, etc.), coordinated multipoint (CoMP), carrier aggregation (CA), or the like. The terminal 120 may perform communication (e.g., uplink communication and/or downlink communication) with the base station 110.

The communication node (i.e., base station, terminal, etc.) constituting the communication network described above may support a code division multiple access (CDMA) based communication protocol, a wideband CDMA (WCDMA) based communication protocol, a time division multiple access (TDMA) based communication protocol, a frequency division multiple access (FDMA) based communication protocol, a single carrier-FDMA (SC-FDMA) based communication protocol, an orthogonal frequency division multiplexing (OFDM) based communication protocol, an orthogonal frequency division multiple access (OFDMA) based communication protocol, or the like.

Among the communication nodes, the base station may be referred to as a Node B, evolved Node B, 5G Node B (gNodeB), base transceiver station (BTS), radio base station, radio transceiver, access point, access node, transmission/reception point (Tx/Rx Point), or the like. Among the communication nodes, the terminal may be referred to as a user equipment (UE), access terminal, mobile terminal, station, subscriber station, portable subscriber station, mobile station, node, device, or the like. The communication node may have the following structure.

FIG. 2 is a block diagram illustrating a communication node constituting a communication network.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

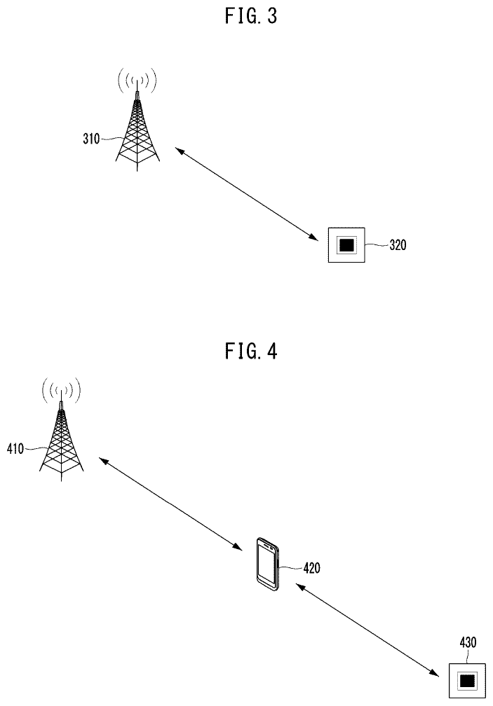

FIG. 3 is a conceptual diagram illustrating a communication network.

Referring to FIG. 3, a base station 310 may support cellular communication (e.g., 5G communication, 6G communication, etc.). The base station 310 may support IoT communication. A device 320 may support IoT communication. The device 320 may not support cellular communication. The base station 310 and the device 320 may perform communication by using an IoT communication scheme. In the present disclosure, the device may be interpreted as an IoT device depending on a context. The IoT device may perform communication by using the IoT communication scheme. In the present disclosure, the base station that performs communication with the device based on the IoT communication scheme may be interpreted as a reader.

FIG. 4 is a conceptual diagram illustrating a communication network.

Referring to FIG. 4, a base station 410 may support cellular communication. The base station 410 may support IoT communication. A terminal 420 may support cellular communication. The terminal 420 may support IoT communication. A device 430 may support IoT communication. The device 430 may not support cellular communication. The base station 410 and the terminal 420 may perform communication by using a cellular communication scheme. The terminal 420 and the device 430 may perform communication by using an IoT communication scheme. In the present disclosure, the terminal that performs communication with the device based on the IoT communication scheme may be interpreted as a reader.

Hereinafter, operation methods of a communication node (e.g., device) in a communication network will be described. Even when a method (e.g., transmission or reception of a signal) to be performed at a first communication node among communication nodes is described, a corresponding second communication node may perform a method (e.g., reception or transmission of the signal) corresponding to the method performed at the first communication node. That is, when an operation of a first terminal (e.g., transmitting terminal) is described, a corresponding second terminal (e.g., receiving terminal) may perform an operation corresponding to the operation of the first terminal. Conversely, when an operation of the second terminal is described, the corresponding first terminal may perform an operation corresponding to the operation of the second terminal. When an operation of a device (e.g., IoT device) is described, a corresponding reader (e.g., base station and/or terminal) may perform an operation corresponding to the operation of the device. Conversely, when an operation of the reader (e.g., base station and/or terminal) is described, the corresponding device may perform an operation corresponding to the operation of the reader.

For convenience of description, the base station or terminal that performs IoT communication with the device illustrated in FIG. 3 and/or FIG. 4 may be referred to as a reader. In reader-to-device (R2D) communication, the reader may transmit a signal, and the device may receive the signal from the reader. In device-to-reader (D2R) communication, the device may transmit a signal, and the reader may receive the signal from the device.

A D2R communication scheme will be described. In the D2R communication scheme, a device may transmit a signal. In the D2R communication scheme, a reader may receive a signal transmitted from the device. In the D2R communication scheme, among channels transmitted from the device to the reader, one channel may be defined as a physical device-to-reader channel (PDRCH). The device may transmit a PDRCH to the reader. The reader may receive the PDRCH from the device.

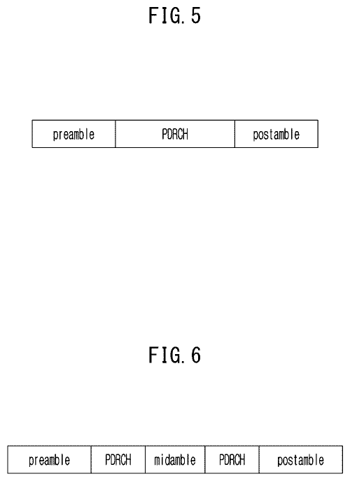

FIG. 5 is a conceptual diagram illustrating exemplary embodiments of a structure of a D2R signal in a communication network.

Referring to FIG. 5, a D2R signal may include a preamble, a PDRCH, and/or a postamble. The preamble included in the D2R signal may be referred to as a D2R preamble. In the present disclosure, a preamble may be interpreted as a D2R preamble depending on a context. The postamble included in the D2R signal may be referred to as a D2R postamble. In the present disclosure, a postamble may be interpreted as a D2R postamble depending on a context. The device may generate a D2R signal including at least one among the preamble, the PDRCH (e.g., PDRCH signal), or the postamble, and may transmit the D2R signal to the reader. The reader may receive the D2R signal from the device. According to a configuration of the D2R signal, the postamble may not be transmitted. In other words, the D2R signal may include the preamble and the PDRCH without the postamble. The preamble may be transmitted before the PDRCH in the time domain. The preamble and the PDRCH may be transmitted consecutively in the time domain. In other words, the PDRCH may be transmitted without a time gap or another signal after the preamble. The postamble may be transmitted after the PDRCH in the time domain. For example, the PDRCH and the postamble may be transmitted consecutively in the time domain. In other words, the postamble may be transmitted without a time gap or another signal after the PDRCH.

FIG. 6 is a conceptual diagram illustrating exemplary embodiments of a structure of a D2R signal in a communication network.

Referring to FIG. 6, a D2R signal may include a preamble, PDRCHs, midambles, and/or a postamble. The D2R signal may include one or more midambles. The midamble included in the D2R signal may be referred to as a D2R midamble. In the present disclosure, a midamble may be interpreted as a D2R midamble depending on a context. The device may generate a D2R signal including at least one among the preamble, the PDRCH, the midamble, or the postamble, and may transmit the D2R signal to the reader. The reader may receive the D2R signal from the device. According to a configuration of the D2R signal, the midamble(s) may not be transmitted. In other words, the D2R signal may include the preamble, the PDRCH, and the postamble without the midamble(s). According to a configuration of the D2R signal, the postamble may not be transmitted. In other words, the D2R signal may include the preamble, the PDRCHs, and the midambles without the postamble.

The preamble may be transmitted before the PDRCH in the time domain. The preamble and the PDRCH may be transmitted consecutively in the time domain. In other words, the PDRCH may be transmitted without a time gap or another signal after the preamble. The midamble may exist between PDRCH transmissions. When a length of the PDRCH is longer than a specific time duration, the midamble may be transmitted. The midamble may be transmitted at a middle point of an entire time duration for PDRCH transmissions (e.g., transmission of the D2R signal). The postamble may be transmitted after the PDRCH in the time domain. The PDRCH and the postamble may be transmitted consecutively in the time domain. In other words, the postamble may be transmitted without a time gap or another signal after the PDRCH.

Hereinafter, a line code will be described. A line code (e.g., line coding) may be one of methods for representing bit information as a waveform.

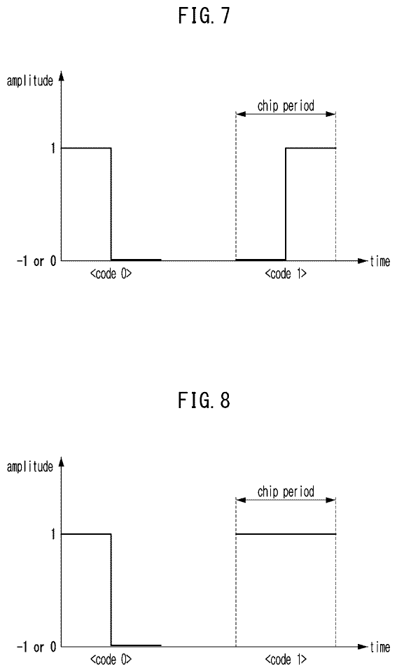

FIG. 7 is a conceptual diagram illustrating exemplary embodiments of line codes in a communication network.

Referring to FIG. 7, a communication node (e.g., a base station, a terminal, a device, or a reader) in a communication network may convert bit information into a waveform based on a line coding scheme. Based on the line coding scheme, bit information 0 may be converted into a form of a code 0 (e.g., a line code 0). Based on the line coding scheme, bit information 1 may be converted into a form of a code 1 (e.g., a line code 1). A time duration length of one code (e.g., code 0 or code 1) may be defined as a chip period of the line code. In the present disclosure, a chip period may mean a chip rate. According to a code, one or more transitions may occur within a chip period. The transition may mean a change in amplitude. For example, a transition may mean a change in amplitude from 0 to 1 or from 1 to 0.

FIG. 8 is a conceptual diagram illustrating exemplary embodiments of line codes in a communication network.

Referring to FIG. 8, a communication node (e.g., a base station, a terminal, a device, or a reader) may convert bit information into a waveform based on a line coding scheme. Based on the line coding scheme, bit information 0 may be converted into a form such as the code 0 of the exemplary embodiment of FIG. 8. Based on the line coding scheme, bit information 1 may be converted into a form such as a code 1 of the exemplary embodiment of FIG. 8. In the exemplary embodiment of FIG. 8, an amplitude of the code 1 may be 1, −1, or 0.

A device may transmit, to a reader through a preamble, information on a chip period (i.e., chip rate) of a line code used for PDRCH transmission. In other words, the device may transmit, to the reader, a preamble indicating the chip period of the line code used for PDRCH transmission. A chip period of a line code used for the preamble and the chip period of the line code applied to a PDRCH may be configured to be identical. The reader may determine that the chip period of the line code applied to the preamble is identical to the chip period of the line code applied to the PDRCH, and may receive the PDRCH based on the determination. In other words, the reader may receive the preamble and the PDRCH based on the same chip period.

The device may transmit, to the reader through the preamble, information on a time duration for one symbol according to a modulation scheme used for PDRCH transmission. In other words, the device may transmit, to the reader, the preamble indicating the time duration for one symbol according to the modulation scheme used for PDRCH transmission. The device may configure a time duration length for one symbol for the preamble and a time duration length for one symbol for the PDRCH to be identical. The device may transmit information on the time duration for one symbol according to the modulation scheme used for PDRCH transmission to the reader. The reader may receive the information (e.g., time duration information) from the device, and may identify the time duration for one symbol according to the modulation scheme used for PDRCH transmission based on the information.

A scheduling method for a PDRCH will be described. PDRCH scheduling information may be indicated through a Physical Reader to Device Channel (PRDCH). The reader may transmit, to the device, a PRDCH (e.g., R2D signal) including the PDRCH scheduling information. The device may receive the PRDCH from the reader and may identify the PDRCH scheduling information included in the PRDCH. The device may perform PDRCH transmission (e.g., D2R transmission) by using the PDRCH scheduling information received through the PRDCH. The PRDCH including the PDRCH scheduling information may be transmitted prior to the PDRCH.

The PDRCH scheduling information may include one or more of the following information items.
Modulation scheme
Line code information
Forward error correction (FEC) information
TB size
Time resource information
Frequency resource information
ID information
Repeated transmission information
Modulation and Coding Scheme (MCS) information
Midamble information

The modulation scheme may indicate a modulation scheme used for PDRCH transmission. The modulation scheme may indicate an OOK scheme or a BPSK scheme. The line code information may include information on a line coding scheme used for the PDRCH. The line code information may include a chip period of a line code used for PDRCH transmission.

The FEC information may include information related to a channel code (i.e., channel coding) used for the PDRCH. The FEC information may include information indicating whether a channel code is applied to the PDRCH. The FEC information may include a code rate of the channel code used for the PDRCH. For example, a code rate indicated by the FEC information may be 1 or 1/3. The code rate 1 may indicate that a channel code is not applied. The channel code may be a convolutional code.

The TB size may indicate a size of a transport block (TB) for PDRCH transmission. The TB size may indicate an amount (e.g., size) of information bits transmitted through the PDRCH. Alternatively, the TB size may indicate a size of a payload transmitted through the PDRCH.

The time resource information may include information on a time resource in which the PDRCH is transmitted. The time resource information may include information on a length (e.g., time duration) of the PDRCH. The time resource information may include information on a transmission time of the PDRCH. The frequency resource information may include information on a frequency resource in which the PDRCH is transmitted. The frequency resource information may include information on at least one of a frequency position or a bandwidth in which the PDRCH is transmitted. The ID information may indicate an ID of the device transmitting the PDRCH. The ID information may indicate an ID of the reader receiving the PDRCH.

The repeated transmission information may include information on whether repeated transmission of the PDRCH is performed, information on a number of repeated transmissions of the PDRCH, information on a repeated transmission type of the PDRCH, and/or information on a repeated transmission pattern of the PDRCH. When the PDRCH is repeatedly transmitted, the repeated transmission information may include information on the repeated transmission type of the PDRCH. The repeated transmission information may indicate whether bit-level repetition for the PDRCH is performed. Alternatively, the repeated transmission information may indicate whether block-level repetition for the PDRCH is performed. A block may refer to a TB. A block may refer to a block (e.g., bit(s)) generated by inserting a CRC into information bits at a higher layer or at a physical layer. Alternatively, the repeated transmission information may indicate whether chip-level repetition for the PDRCH is performed. A chip may refer to a modulation symbol, a demodulation symbol, or a chip of the line code. When the PDRCH is repeatedly transmitted, the repeated transmission may refer to repetition performed within a single PDRCH. Whether the repeated transmission is applied may not affect a number of PDRCHs transmitted.

The MCS information may include information on a modulation scheme and/or a code rate used for PDRCH transmission. The midamble information may include information on a transmission interval and/or a length of a midamble used for PDRCH transmission. A method of indicating a chip period in the PDRCH scheduling information will be described. The chip period may be included in the line code information. The chip period may correspond to the chip period in the exemplary embodiment of FIG. 7. Alternatively, the chip period may be a time duration corresponding to one amplitude in the chip period in the exemplary embodiment of FIG. 7. The chip period may be half of the chip period in the exemplary embodiment of FIG. 7. Alternatively, the chip period may be a length of one modulated symbol in the time domain. The chip period may be used with the same meaning as a chip length.

The chip period of the PDRCH may be indicated through PRDCH control information. The reader may transmit information on the chip period used for PDRCH transmission by using the PRDCH control information. The device may receive the PRDCH control information and may identify information on the chip period used for PDRCH transmission based on the PRDCH control information (e.g., PDRCH scheduling information).

The chip period of the PDRCH may be indicated by an R2D preamble (e.g., a preamble included in an R2D signal). In an R2D transmission, an R2D preamble may refer to a preamble transmitted prior to a PRDCH in the time domain. The PRDCH may include scheduling information for the PDRCH transmitted by using the indicated chip period. The PRDCH transmission and the PDRCH transmission may be performed by using an identical chip period. The chip period indicated by the R2D preamble may indicate the chip period of the PRDCH. The chip period indicated by the R2D preamble may indicate the chip period of the PDRCH. In other words, the chip period of the PRDCH and the chip period of the PDRCH may be indicated by the same R2D preamble. The device may identify the chip period based on the R2D preamble and may perform PRDCH reception by using the identified chip period. The device may identify the chip period based on the R2D preamble and may perform PDRCH transmission by using the identified chip period. When the chip period for the R2D preamble is assumed to be identical to the chip period of the PRDCH and/or the chip period of the PDRCH, the above-described R2D preamble-based chip period indication method may be used.

The chip period of the PDRCH may be indicated through the R2D preamble and PRDCH control information (e.g., control channel). The R2D signal may include the preamble (e.g., R2D preamble) and the PRDCH, and the PRDCH may include control information and a payload. The control information included in the PRDCH may be referred to as PRDCH control information. The payload included in the PRDCH may be referred to as a PRDCH payload (e.g., PRDCH data). The reader may transmit, to the device, the R2D signal including the R2D preamble. In the present disclosure, a term ‘R2D signal’ may be interpreted as a PRDCH according to a context. The device may receive the R2D signal from the reader and may identify the chip period used for the R2D preamble included in the R2D signal. The PRDCH control information may include an offset for determining the chip period of the PDRCH. The device may identify information on the chip period used for PDRCH transmission by applying the offset to the chip period used for the R2D preamble. The offset may be set as a multiple of the chip period used for the R2D preamble. For example, the chip period used for the R2D preamble may be T, and the offset indicated by the reader may be N. N may be an actual value or an index corresponding to the actual value.

The device may determine the chip period S used for PDRCH transmission based on the chip period T and the offset N. The device may determine the chip period S used for PDRCH transmission based on Equation 1 below.

$$S = T \times N \qquad [ Equation 1 ]$$

In Equation 1, N may be a natural number, or N may be a fraction having a natural number as a denominator. As another exemplary embodiment, the device may determine the chip period S used for PDRCH transmission based on Equation 2 below. In Equation 2, N may be an integer.

$$S = T \times {( 2 )}^{N} \qquad [ Equation 2 ]$$

As another exemplary embodiment, the chip period of D2R transmission may be determined based on a PDRCH transmission bandwidth. The device may determine 1/(PDRCH transmission bandwidth) as the chip period of the PDRCH. In this case, the communication node (e.g., the device and/or the reader) may identify the chip period of the PDRCH based on the PDRCH transmission bandwidth without a separate indication for the chip period of the PDRCH.

A time resource scheduling method for PDRCH transmission will be described. A start time of PDRCH transmission may be determined based on PDRCH scheduling information included in a PRDCH (e.g., PDRCH scheduling information transmitted through the PRDCH). The reader may indicate, to the device, transmission time information of the PDRCH (e.g., start time information) through PDRCH scheduling information in PDRCH control information included in the PRDCH (e.g., PRDCH control information transmitted through the PRDCH). The device may identify a transmission time of the PDRCH based on the information indicated by the reader.

The transmission time information of the PDRCH may indicate at least one of a start time of PDRCH transmission or an end time of PDRCH transmission. The start time of PDRCH transmission may refer to a start time of the PDRCH or a start time of a D2R transmission including the PDRCH and a preamble located prior to the PDRCH. The end time of PDRCH transmission may indicate an end time of the PDRCH or an end time of a D2R transmission including the PDRCH and a postamble located after the PDRCH. When transmission of the PDRCH is possible at the PDRCH transmission time indicated by the reader, the device may perform transmission of the PDRCH. When transmission of the PDRCH is not possible at the PDRCH transmission time indicated by the reader, the device may not perform transmission of the PDRCH.

A time unit indicating the PDRCH transmission time may be a time unit of PRDCH transmission including the PDRCH scheduling information. The PDRCH transmission time may be indicated by using the time unit used for PRDCH transmission (e.g., a length of a modulation symbol or a chip period of a line code).

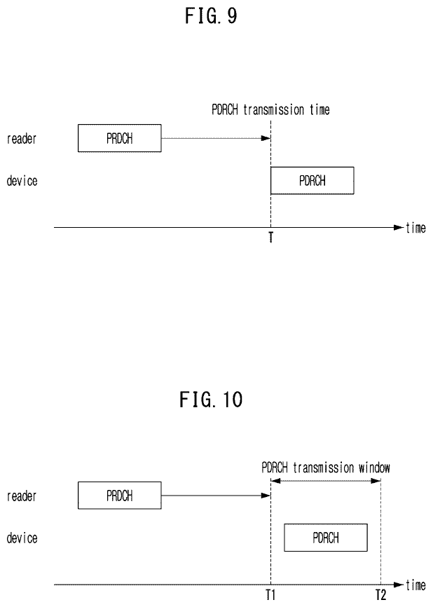

FIG. 9 is a conceptual diagram illustrating a PDRCH scheduling method.

Referring to FIG. 9, a reader may transmit, to a device, a PRDCH (e.g., R2D signal) including PDRCH scheduling information. The PDRCH scheduling information may include transmission time information of a PDRCH. The device may receive the PRDCH from the reader and may identify the transmission time information of the PDRCH through the PRDCH. When transmission of the PDRCH is possible at a time indicated by the PRDCH (e.g., PDRCH scheduling information), the device may transmit the PDRCH. When transmission of the PDRCH is not possible at the time indicated by the PRDCH (e.g., PDRCH scheduling information), the device may not transmit the PDRCH.

As another exemplary embodiment of a PDRCH scheduling method, time duration information for PDRCH transmission may be included in the PRDCH (e.g., PDRCH scheduling information). When transmission of the PDRCH is possible within a time duration indicated by the PRDCH (e.g., PDRCH scheduling information), the device may transmit the PDRCH. When transmission of the PDRCH is not possible within the time duration indicated by the PRDCH (e.g., PDRCH scheduling information), the device may not transmit the PDRCH.

The communication node (e.g., the device and/or the reader) may identify the time duration (e.g., time duration information) based on a start time of the time duration and an end time of the time duration. Alternatively, the communication node (e.g., the device and/or the reader) may identify the time duration (e.g., time duration information) based on a start time of the time duration and a length of the time duration. For convenience of description, in the present disclosure, the time duration may be referred to as a ‘PDRCH transmission window’.

A start time of the PDRCH transmission window may be indicated based on a time offset from an end time of PRDCH transmission. The end time of PRDCH transmission may indicate an end time of the PRDCH or an end time of a postamble after the PRDCH. Alternatively, the start time of the PDRCH transmission window may be indicated based on a time offset from a transmission end time of PRDCH control information. Alternatively, the start time of the PDRCH transmission window may be indicated based on a time offset from a start time of PRDCH transmission.

An end time of the PDRCH transmission window may be indicated based on a time offset from an end time of PRDCH transmission. The end time of PRDCH transmission may indicate an end time of the PRDCH or an end time of a postamble after the PRDCH. Alternatively, the end time of the PDRCH transmission window may be indicated based on a time offset from a transmission end time of PRDCH control information. Alternatively, the end time of the PDRCH transmission window may be indicated based on a time offset from a start time of PRDCH transmission. Alternatively, the end time of the PDRCH transmission window may be determined based on the start time of the PDRCH transmission window and a time duration length of the PDRCH transmission window.

The start time and the end time of the PDRCH transmission window may be predefined times (e.g., values). The predefined times may be defined based on time offsets from a reference time (e.g., the end time of the PRDCH). The device may identify a reception end time of the PRDCH and the PDRCH scheduling information by receiving the PRDCH. The device may identify the PDRCH transmission window by using the start time and the end time of the PDRCH transmission window, which are predefined by the system. The device may perform PDRCH transmission within the PDRCH transmission window. When transmission of the PDRCH is not possible within the PDRCH transmission window, the device may not perform the PDRCH transmission.

As another exemplary embodiment, at least one time among the start time or the end time of the PDRCH transmission window may be a predefined time (e.g., value). The predefined time may be defined based on a time offset from a reference time (e.g., an end time of the PRDCH). One time that is not predefined among the start time or the end time of the PDRCH transmission window may be indicated to the device by the PDRCH scheduling information included in the PRDCH. The device may identify a reception end time of the PRDCH and the PDRCH scheduling information by receiving the PRDCH. The device may identify the PDRCH transmission window using the start time or the end time of the PDRCH transmission window predefined by the system and/or the end time or the start time of the PDRCH transmission window indicated by PDRCH scheduling information included in the PRDCH. The device may perform PDRCH transmission within the PDRCH transmission window. When transmission of the PDRCH is not possible within the PDRCH transmission window, the device may not perform the PDRCH transmission.

The start time information and end time information of the PDRCH transmission window may be indicated to the device by the PDRCH scheduling information transmitted through the PRDCH. The device may identify a reception end time of the PRDCH and the PDRCH scheduling information by receiving the PRDCH. The device may identify the PDRCH transmission window by using the start time information and end time information of the PDRCH transmission window in the PDRCH scheduling information received through the PRDCH. The device may perform PDRCH transmission within the PDRCH transmission window. When transmission of the PDRCH is not possible within the PDRCH transmission window, the device may not perform the PDRCH transmission.

The reader may perform signal monitoring for PDRCH reception based on the transmission time information of the PDRCH indicated to the device. When a PDRCH is not received at the transmission time indicated to the device, the reader may determine that PDRCH transmission is not performed by the device. The reader may determine that the PRDCH including the PDRCH scheduling information is not successfully received by the device. The reader may perform retransmission for the PRDCH including the PDRCH scheduling information.

When the reader indicates, to the device, information on the PDRCH transmission window for PDRCH transmission, the reader may perform signal monitoring for PDRCH reception within the PDRCH transmission window. The reader may not perform signal monitoring for PDRCH reception after the end time of the PDRCH transmission window.

FIG. 10 is a conceptual diagram illustrating a PDRCH scheduling method.

Referring to FIG. 10, a reader may indicate PDRCH transmission window information to a device through a PRDCH. The device may identify the PDRCH transmission window information through the PRDCH. When transmission of a PDRCH is possible at a time indicated by the PRDCH, the device may transmit the PDRCH within the PDRCH transmission window. When transmission of the PDRCH is not possible within the PDRCH transmission window indicated by the PRDCH, the device may not transmit the PDRCH.

A configuration of a PRDCH indicating PDRCH scheduling information will be described.

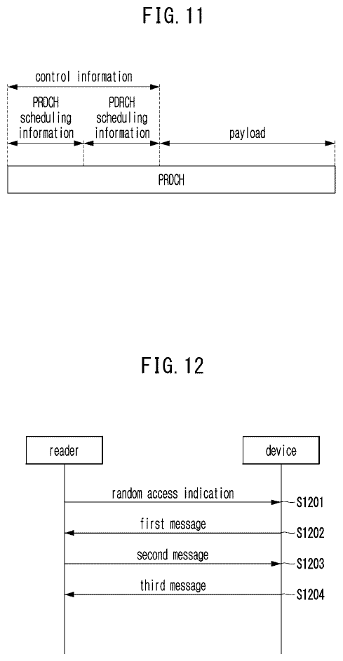

FIG. 11 is a conceptual diagram illustrating a PRDCH configuration in a communication network.

Referring to FIG. 11, a PRDCH may include control information and a payload. The control information included in the PRDCH may refer to PRDCH control information. The payload included in the PRDCH may refer to a PRDCH payload. The control information may include at least one of PRDCH scheduling information or PDRCH scheduling information. The control information may be transmitted at a beginning part of the PRDCH. The payload may be transmitted after the control information. Within the control information, PRDCH scheduling information may be located in a front region in the time domain, and PDRCH scheduling information may be located after the PRDCH scheduling information. The PRDCH scheduling information and the PDRCH scheduling information may be transmitted consecutively without a time gap.

The PDRCH scheduling information may or may not be transmitted within the PRDCH control information according to a system configuration. Whether the PRDCH control information includes the PDRCH scheduling information may be indicated by information within the PRDCH control information. Whether the PRDCH control information includes the PDRCH scheduling information may be indicated by using bit information within the PRDCH control information. Based on whether the PRDCH control information includes the PDRCH scheduling information, a length of the PRDCH control information may vary. When the PRDCH control information does not include the PDRCH scheduling information, the PRDCH control information may include the PRDCH scheduling information and information indicating whether the PRDCH control information includes the PDRCH scheduling information. In this case, the PDRCH scheduling information may not be transmitted through the PRDCH. When the PRDCH control information includes the PDRCH scheduling information, the PRDCH control information may include the PRDCH scheduling information, information indicating whether the PRDCH control information includes the PDRCH scheduling information, and the PDRCH scheduling information. By using the information indicating whether the PRDCH control information includes the PDRCH scheduling information, the device may identify a time duration length of the control information in PRDCH transmission. By using the information indicating whether the PRDCH control information includes the PDRCH scheduling information, the device may identify whether the PRDCH transmission schedules a PDRCH transmission.

The PRDCH control information may be transmitted separately from the PRDCH. The PRDCH control information and the PRDCH may be multiplexed in the time domain, and the PRDCH control information and the PRDCH multiplexed in the time domain may be transmitted. A separate time region (e.g., time resource) for transmission of the PRDCH control information may be allocated, and the PRDCH control information may be transmitted in the allocated time region. The PRDCH control information and the PRDCH may be transmitted using different PRDCH formats. For example, a PRDCH format for transmission of the PRDCH control information and a PRDCH format for transmission of the PRDCH may independently exist. The PRDCH control information and the PRDCH may be transmitted by using the respective PRDCH formats. The PRDCH control information may be transmitted by using a MAC layer message. In other words, the PRDCH control information may be included in the MAC layer message. The PDRCH scheduling information may be transmitted by using a MAC layer message. The PRDCH scheduling information may be transmitted by using a physical layer channel (e.g., L1 control information or DCI).

CRC bits (e.g., CRC field) may be inserted into the PDRCH. Different CRC bits may be inserted into the PDRCH according to a time length or a bit length of the PDRCH. Based on whether the length of the PDRCH exceeds a threshold, different CRC bits may be inserted into the PDRCH. CRC bits having a long length may be inserted into a PDRCH having a long length. CRC bits having a short length may be inserted into a PDRCH having a short length. For example, when an information length of the PDRCH is X bits or less, a CRC composed of A bits may be applied to the PDRCH. When the information length of the PDRCH exceeds X bits, a CRC composed of B bits may be applied to the PDRCH. Each of X, A, and B may be a natural number. For example, X may be 24, A may be 6, and B may be 16.

As another exemplary embodiment, whether CRC bits are inserted may be determined based on whether the length (e.g., information length) of the PDRCH exceeds a threshold. When the length of the PDRCH is Y bits or less, a CRC may not be inserted into the PDRCH. When the length of the PDRCH exceeds Y bits, a CRC may be inserted into the PDRCH. As another exemplary embodiment, whether CRC bits are inserted may be determined based on a type of a message transmitted through the PDRCH.

The reader may identify whether a PDRCH is successfully received based on CRC verification (e.g., CRC check) for the PDRCH. When the reader successfully receives the PDRCH, the reader may transmit ACK information for the PDRCH to the device. When the reader does not successfully receive the PDRCH, the reader may transmit NACK information for the PDRCH to the device.

CRC bits (e.g., CRC field) may be inserted into the PRDCH. For example, the reader may apply one CRC (e.g., one CRC encoding) to the control information and the payload within the PRDCH. As another example, the reader may apply one CRC (e.g., one CRC encoding) to the control information within the PRDCH, and may apply another CRC (e.g., another CRC encoding) to the payload within the PRDCH. In other words, CRC checks for the control information and the payload within the PRDCH may be independently performed. In insertion of CRC bits for the PRDCH, different CRC bits may be inserted into the PRDCH according to a time length or a bit length of the PRDCH. For example, based on whether the length of the PRDCH exceeds a threshold, different CRC bits may be inserted into the PRDCH. CRC bits having a long length may be inserted into a PRDCH having a long length. CRC bits having a short length may be inserted into a PRDCH having a short length. For example, when the length (e.g., information length) of the PRDCH is X bits or less, a CRC composed of A bits may be applied to the PRDCH. When the length of the PRDCH exceeds X bits, a CRC composed of B bits may be applied to the PRDCH. Each of X, A, and B may be a natural number. For example, X may be 24, A may be 6, and B may be 16.

As another exemplary embodiment, whether CRC bits are inserted may be determined based on whether the length (e.g., information length) of the PRDCH exceeds a threshold. When the length of the PRDCH is Y bits or less, a CRC may not be inserted into the PRDCH. When the length of the PRDCH exceeds Y bits, a CRC may be inserted into the PRDCH. As another exemplary embodiment, whether CRC bits are inserted may be determined based on a type of a message transmitted through the PRDCH.

The device may identify whether a PRDCH is successfully received based on CRC verification (e.g., CRC check) for the PRDCH. When the device successfully receives the PRDCH, the device may transmit ACK information for the PRDCH to the reader. When the device does not successfully receive the PRDCH, the device may transmit NACK information for the PRDCH to the reader.

The device may transmit PDRCH control information to the reader. The PDRCH control information may include at least one of normal reception information for PRDCH transmission (e.g., ACK or NACK) or operation information of the device. The PDRCH control information may be transmitted through a physical layer message. Alternatively, the PDRCH control information may be transmitted through a higher layer message (e.g., MAC layer message). The operation information of the device may include at least one of battery information of the device, next operation time information of the device, or information on a time during which signal reception is possible at the device. The reader may receive the PDRCH control information from the device and may identify at least one of whether the PRDCH has been received at the device or the operation information of the device based on the PDRCH control information.

The device may multiplex the PDRCH control information and the PDRCH in the time domain and may transmit the PDRCH control information and the PDRCH multiplexed in the time domain to the reader. The device may transmit the PDRCH control information and the PDRCH payload (e.g., PDRCH data) by using independent PDRCH formats, respectively. A PDRCH format for transmission of the PDRCH control information and a PDRCH format for transmission of the PDRCH data may be defined. The device may transmit the PDRCH control information by using the PDRCH format for transmission of the PDRCH control information.

A transmission scheme of a PDRCH will be described. A device may transmit a PDRCH by using a single-carrier-based transmission scheme. The PDRCH may be transmitted, according to a type of the device, by using backscattering through impedance matching for a signal received by the device. Alternatively, the PDRCH may be transmitted, according to the type of the device, by generating a signal by the device itself. For power supply required for signal transmission and/or signal reception, the device may use an energy harvesting scheme of charging energy from a radio frequency (RF) signal.

For D2R transmissions (e.g., PDRCH transmissions) of a plurality of devices, a multiple access scheme may be applied. According to a system configuration, a time domain multiple access (TDMA) scheme or a frequency domain multiple access (FDMA) scheme may be used. According to a system configuration, the TDMA scheme and the FDMA scheme may be used together.

The TDMA scheme may be based on a slotted Aloha scheme. In the slotted Aloha scheme, time resources may be divided into units of a slot, and a random access procedure may be performed on a slot basis. The reader may transmit resource information for TDMA to the device. The information for TDMA may be referred to as TDMA configuration information. In the present disclosure, information transmitted by the reader to the device may be included in an R2D signal (e.g., PRDCH control information), and information transmitted by the device to the reader may be included in a D2R signal (e.g., PDRCH control information). The reader may transmit, to the device, at least one of length information of a time duration of one slot, start time information of a slot, or information on a total number of slots. The device may receive the information from the reader and may use the received information for TDMA.

The FDMA scheme may be differently applied according to a device type. The device transmitting a PDRCH by using backscattering through impedance matching for a signal received by the device may be classified into a “device type 1”. The device transmitting a PDRCH by generating a signal by itself may be classified into a “device type 2”.

For FDMA for device type 2, the reader may transmit, to the device, PDRCH scheduling information including information indicating a frequency resource for PDRCH transmission, and the device may perform PDRCH transmission in the frequency resource indicated by the PDRCH scheduling information received from the reader. The information for FDMA included in the PDRCH scheduling information may be referred to as FDMA configuration information.

For FDMA for device type 1, the reader may transmit, to the device, PDRCH scheduling information including a line code and/or repeated transmission information used for PDRCH transmission, and the device may perform PDRCH transmission by using the line code and/or repeated transmission information indicated by the PDRCH scheduling information received from the reader. The device may perform PDRCH transmission by using frequency shifting. The device may multiplex the PDRCH (e.g., D2R signal) in the frequency domain by using frequency shifting, and may transmit the multiplexed PDRCH (e.g., D2R signal) to the reader.

The reader may generate PDRCH scheduling information including at least one of frequency resource information for PDRCH transmission, a line code used for PDRCH transmission, or repeated transmission information, and may transmit the PDRCH scheduling information to the device. The device may receive the PDRCH scheduling information from the reader and may identify the information included in the PDRCH scheduling information. The device may determine a frequency resource for PDRCH transmission according to the device type, and may perform PDRCH transmission in the determined frequency resource. Alternatively, the device may perform an FDMA operation by using a frequency shifting scheme based on application of a line code and/or application of repeated transmission according to the device type. In other words, the device may use frequency shifting to perform FDMA. The reader may receive a D2R signal (e.g., PDRCH) from the device based on the FDMA configuration information. In other words, the reader may receive a D2R signal (e.g., PDRCH) multiplexed in the frequency domain from the device.

A random access method in a communication system will be described. In the communication system, the reader may indicate performance of a random access procedure to the device. In other words, the reader may transmit, to the device, information indicating performance of a random access procedure. The device may receive, from the reader, the information indicating performance of a random access procedure. The device may perform a random access procedure based on the indication of performance of a random access procedure. In the present disclosure, the information indicating performance of a random access procedure may be referred to as a random access indication. Transmission of the random access indication may refer to PRDCH transmission. The PRDCH transmission may include scheduling information for first message transmission (e.g., Msg1 or MsgA transmission) initiated by the random access indication. The first message transmission may refer to PDRCH transmission. In other words, the PDRCH transmission may include the first message transmission. The random access indication may refer to an indication identical or similar to a physical downlink control channel (PDCCH) order.

Although exemplary embodiments of the present disclosure are described focusing on operations of a device, a reader may also perform operations corresponding to the operations of the device. For example, although exemplary embodiments of the present disclosure are described focusing on a scheme in which a device determines a resource position (e.g., a position of a time resource and/or a position of a frequency resource) for first message transmission (e.g., Msg1 or MsgA transmission), the reader may also determine a resource position in which the first message is received in an identical or similar manner to that of the device.

FIG. 12 is a sequence diagram illustrating a random access procedure of a device.

Referring to FIG. 12, a reader may transmit a random access indication to a device (S1201). The device may receive the random access indication from the reader (S1201). Based on reception of the random access indication, the device may perform a random access procedure. The device may transmit, to the reader, a first message (e.g., Msg1 or MsgA) based on information included in the random access indication (e.g., a message or information including the random access indication) (S1202). The first message may be transmitted based on configuration information (e.g., random access channel (RACH) configuration information for IoT devices) received in advance from another communication node (e.g., a base station). The reader may receive the first message from the device (S1202). The reader may transmit, to the device, a second message (e.g., Msg2 or MsgB) based on the first message (S1203). The second message may be transmitted as a response to the first message. The device may receive the second message from the reader after transmission of the first message (S1203). The second message transmission (transmission of the second message) may refer to PRDCH transmission. In other words, the PRDCH transmission may include the second message transmission. The device may transmit, to the reader, a third message (e.g., Msg3) based on the second message (S1204). The third message may be transmitted as a response to the second message. The reader may receive the third message from the device after transmission of the second message (S1205). The third message transmission (transmission of the third message) may refer to PDRCH transmission. In other words, the PDRCH transmission may include the third message transmission.

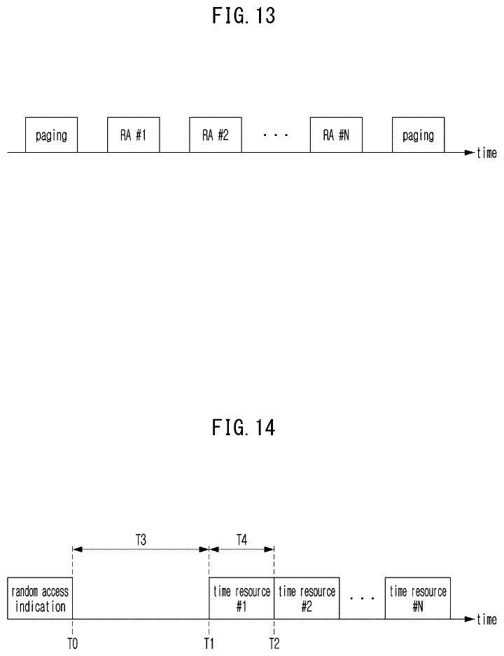

FIG. 13 is a conceptual diagram illustrating a random access procedure of a device.

Referring to FIG. 13, a reader may transmit a paging message to a device. The device may receive the paging message from the reader. The paging message may include information (e.g., some required information) required for the device to perform a random access procedure. After the reader transmits the paging message (e.g., after the device receives the paging message), the random access procedure between the reader and the device may be performed. The random access procedure may include a transmission and reception procedure for at least one of the random access indication, the first message, the second message, or the third message as in the exemplary embodiment of FIG. 12. One or more random access procedures may be performed for one paging message of the reader. In other words, one paging message may cause one or more random access procedures. The device may participate in one random access procedure among N random access procedures (e.g., Random access (RA) #1, RA #2, . . . RA #N) associated with the one paging message. The device may not participate in two or more random access procedures among N random access procedures. N may be a natural number.

The paging message may include one or more of the following information items.
Random access type (e.g., contention-based random access or contention-free random access)
Information indicating whether a paging identifier (ID) is present
Length information of a paging ID
Paging ID
Number N of random access procedures associated with one paging message
Scheme of a random access procedure (e.g., a first scheme of transmitting and receiving two messages (e.g., a first message and a second message), a second scheme of transmitting and receiving three messages (e.g., a first message, a second message, and a third message), or a third scheme of transmitting and receiving four messages (e.g., a first message, a second message, a third message, and a fourth message))
Scheduling information of a first message (e.g., Msg1 or MsgA)

The device may receive the paging message including one or more of the information items described above from the reader. The device may perform a random access procedure by using one or more of the information items included in the paging message and information obtained through a random access trigger message. The device may receive the paging message from the reader and may identify the paging ID information included in the paging message. The paging ID information may include at least one of information indicating whether a paging ID is present, length information of the paging ID, or the paging ID. The device may determine whether to perform a random access procedure associated with the paging message based on the paging ID information included in the paging message.

The information indicating whether a paging ID is present may indicate whether a paging ID is transmitted through the paging message. Presence of a paging ID in the paging message may indicate that the paging message is a paging message for a specific device or a specific device group. Absence of a paging ID in the paging message may indicate that the paging message is a paging message for all devices or an unspecified number of devices receiving the paging message.

The device may receive the paging message and may identify whether a paging ID is present in the paging message. Based on absence of a paging ID in the paging message, the device may determine that the paging message is a paging message for the device, and the device may perform a random access procedure associated with the paging message. The random access procedure may include a transmission and reception procedure for a random access trigger message. In other words, the random access procedure may include a transmission and reception procedure for the random access trigger message and a transmission and reception procedure for a first message, a second message, and/or a third message based on the random access trigger message. The random access trigger message may be transmitted from the reader to the device.

The device may receive the paging message and may identify whether a paging ID is present in the paging message. Based on presence of a paging ID in the paging message, the device may deliver the paging ID to a higher layer (e.g., a higher layer of the device). The higher layer of the device (e.g., an entity supporting higher layer functions) may determine whether the paging ID matches a device ID. Based on the paging ID matching the device ID, the device (e.g., the higher layer of the device) may determine that the paging message is a paging message for the device. The paging ID may match an ID of a specific device or an ID of a group of one or more devices. Based on the paging message being a paging message for the device, the device may perform a random access procedure associated with the paging message. The random access procedure may include a transmission and reception procedure for a random access trigger message. In other words, the random access procedure may include a transmission and reception procedure for the random access trigger message and a transmission and reception procedure for a first message, a second message, and/or a third message based on the random access trigger message. Based on the paging ID not matching the device ID, the device (e.g., the higher layer of the device) may determine that the paging message including the paging ID is not a paging message for the device. Based on the paging message not being a paging message for the device, the device may not perform a separate random access procedure until reception of a next paging message.

Information included in the paging message may indicate a type of a random access procedure. The device may perform a random access procedure based on the type of a random access procedure indicated by the paging message. Based on the paging message indicating CBRA, the device may perform a contention-based random access procedure. Based on the paging message indicating CFRA, the device may perform a contention-free random access procedure.

The reader may transmit, to the device, information required for a random access procedure through the random access indication. The random access procedure may be initiated based on the random access indication, and information required for first message transmission may be included in the random access indication. The device may receive the random access indication from the reader. The device may obtain information required for a random access procedure through the random access indication received from the reader, and the device may transmit a first message to the reader based on the obtained required information. The reader may receive the first message from the device. The reader may perform a reception operation of the first message based on the information included in the random access indication.

The random access indication may include one or more of the following information items, and the reader may transmit, to the device, the random access indication including the one or more information items.
Random access type
Time resource information indicating a time resource through which a first message is transmitted
Frequency resource information indicating a frequency resource through which the first message is transmitted
ID information of a device performing a random access procedure
Scheduling information for transmission of the first message
Remaining random access counter
Information indicating whether a fourth message is transmitted
End time of a current random access procedure
Start time of a next random access procedure

The random access type may indicate a contention-based random access procedure or a contention-free random access procedure. In the contention-based random access procedure, one or more devices may transmit signals (e.g., first messages) in one resource (e.g., one transmission resource). In the contention-free random access procedure, only one device may transmit a signal (e.g., first message) in one resource (e.g., one transmission resource). The reader may indicate, to the device, a type (e.g., CBRA or CFRA) of a random access procedure to be performed by the device. A size of information indicating the type of the random access procedure may be 1 bit. For example, information set to a first value (e.g., 0) may indicate CBRA, and information set to a second value (e.g., 1) may indicate CFRA.

As another exemplary embodiment, the random access type may indicate a number of messages transmitted and received between the reader and the device in the random access procedure. The random access type may indicate a 2-step random access procedure or a 3-step random access procedure. In the 2-step random access procedure, two messages (e.g., a first message and a second message) may be transmitted and received. For example, in the 2-step random access procedure, the device may transmit the first message to the reader, and the reader may transmit the second message to the device. The 2-step random access procedure may end when transmission and reception operations of two messages are completed. In the 3-step random access procedure, three messages (e.g., a first message, a second message, and a third message) may be transmitted and received. For example, in the 3-step random access procedure, the device may transmit the first message to the reader, the reader may transmit the second message to the device, and the device may transmit the third message to the reader. The 3-step random access procedure may end when transmission and reception operations of three messages are completed.

The time resource information for transmission of the first message may include information on a time resource used by the device for transmission of the first message.

The frequency resource information for transmission of the first message may include information on a frequency resource used by the device for transmission of the first message.

The ID information (e.g., device ID) of the device performing a random access procedure may include ID information of the device that receives the random access indication and performs the random access procedure. The device performing the random access procedure may refer to a device transmitting the first message. For example, the ID information may be one ID of a specific device. As another example, the ID information may be a group ID assigned to a device group including one or more devices. As another example, the ID information may be a group ID assigned to one or more device groups. The ID information may be an ID indicating an unspecified number of devices. Based on the ID information of a device performing a random access procedure being an ID indicating an unspecified number of devices, the device receiving the random access indication may perform a random access procedure regardless of an ID of the device. As another example, the ID information of a device performing a random access procedure may include one or more IDs. Based on presence of an ID of the device (e.g., an ID associated with the device) among the one or more IDs, the device may perform a random access procedure.

The remaining random access counter may indicate the number of remaining rounds of a random access procedure currently being performed.

The information indicating whether transmission of a fourth message is performed may indicate whether the reader transmits a fourth message in a random access procedure (e.g., a current random access procedure).

The end time of a current random access procedure may indicate an end time (e.g., an expected end timing) of a random access procedure currently being performed.

The start time of a next random access procedure may indicate a start time (e.g., an expected start time) of a next random access procedure.

The scheduling information for transmission of a first message may include information (e.g., parameters) on environment variables used by the device to transmit the first message. The scheduling information for transmission of a first message may include one or more of the following information items.
Modulation scheme
Line code information
Bit length information
Forward error correction (FEC) information
Transport block (TB) size
Time resource information
Frequency resource information
ID information
Repeated transmission information
MCS information
Midamble information

The bit length information may indicate time length information of one bit used by the device for D2R transmission. The FEC information may indicate whether FEC is applied to D2R transmission. The repeated transmission information may indicate whether repeated transmission is applied. The midamble information may include a time interval between midambles or a time interval between a preamble and a midamble. The midamble information may include a sequence type of the midamble or the preamble. The sequence type may indicate a sequence length. The midamble information may indicate whether an additional midamble is transmitted. For example, the midamble information may indicate whether a midamble is additionally transmitted at an end time of a PDRCH.

Apart of scheduling information for first message transmission may be transmitted through a physical layer message. A part of scheduling information for first message transmission may be transmitted through a higher layer message. The part of scheduling information may be information commonly applied to a random access indication and scheduling for a first message. For example, ID information of a device receiving a random access indication and ID information of a device receiving scheduling information for first message transmission may be information commonly applied to scheduling of the random access indication and scheduling of the first message. The ID information may be included in the scheduling information of the random access indication or the scheduling information of the first message, and the ID information may be used for scheduling of the random access indication and scheduling of the first message. For example, the ID information may be transmitted through the scheduling information of the random access indication, and the ID information may be used for scheduling of the random access indication and scheduling of the first message. The ID information may be transmitted through a physical layer message. Alternatively, the ID information may be transmitted through a higher layer message.

The device may receive a paging message or a random access trigger message from the reader. Based on reception of the paging message or the random access trigger message, the device may transmit a first message. The first message may include ID information of the device (e.g., the device transmitting the first message). The ID information of the device may be information arbitrarily generated at the device. The ID information of the device may be composed of N bits. N may be a natural number. For example, N may be 16.

The device may receive transmission occasion information for the first message. The transmission occasion information for the first message may be included in the paging message. The device may identify the transmission occasion information for the first message through the paging message received from the reader. The transmission occasion information for the first message may include information indicating a number of total transmission occasions. The number of total transmission occasions may be the number of transmission occasions in which the first message corresponding to one paging message is transmittable.

The device may select a random number to determine a transmission resource of the first message. The random number may be 0 or more and may be less than the number of total transmission occasions. The device may set the random number to a random access counter of the device.

The device may compare the random access counter of the device with a threshold. The threshold may be the number K of transmission occasions in which the first message corresponding to one random access trigger message is transmittable. In other words, the number K may indicate the number of transmission resources in the time and frequency domains in which the first message is transmittable when one random access trigger message is received. For example, based on presence of X resources for first message transmission in the time domain and presence of Y resources for first message transmission in the frequency domain for one random access trigger message, the number K of transmission occasions in which the first message corresponding to one random access trigger is transmittable may be X×Y.

The device may compare the random access counter of the device with a threshold. When the random access counter of the device is smaller than the threshold, the device may perform first message transmission. The first message transmission of the device may be performed on a transmission resource for first message transmission corresponding to the random access counter of the device.

The device may compare the random access counter of the device with a threshold. When the random access counter of the device is equal to or greater than the threshold, the device may not perform first message transmission in a transmission resource for first message transmission corresponding to the random access trigger message. The device may receive a next random access trigger message. When the next random access trigger message is received, the device may decrease the random access counter of the device by one. After decreasing the random access counter of the device, the device may compare the random access counter of the device (e.g., the decreased random access counter) with the threshold.

The device may compare the random access counter of the device with a threshold. When the random access counter of the device is smaller than the threshold, the device may perform first message transmission. When the random access counter of the device is equal to or greater than the threshold, the device may not perform first message transmission in a transmission resource for first message transmission corresponding to the random access trigger message. The device may repeatedly perform the process described above. The device may repeatedly perform the process described above until reception of a new paging message.

A transmission resource used for first message transmission of a device will be described. The resource used for first message transmission of the device may be a time resource and/or a frequency resource.

Time resources available for first message transmission may be indicated to the device through a paging message or a random access indication. The reader may transmit, to the device, the paging message or the random access indication including information indicating the time resources available for first message transmission. The paging message or the random access indication may include one or more of the following information items.
Time duration length from a transmission end time of a random access indication to a start time of time resources available for first message transmission
Time duration length from the transmission end time of the random access indication to a start time of the first time resource available for first message transmission
Time duration length from the transmission end time of the random access indication to a start time of the second time resource available for first message transmission
Time duration length from a start time of the first time resource available for first message transmission to a start time of the second time resource available for first message transmission
Time duration length from an end time of the first time resource available for first message transmission to the start time of the second time resource available for first message transmission
Time duration length of one time resource among time resources available for first message transmission
Number of time resources available for first message transmission

FIG. 14 is a conceptual diagram illustrating time resource configuration for first message transmission by a device.

Referring to FIG. 14, a reader may transmit a random access indication to a device. The device may receive the random access indication from the reader. The device may identify time resources available for first message transmission based on the random access indication. The time resources available for first message transmission may be composed of one or more time resources. For example, the time resources available for first message transmission may be composed of N time resources. The device may perform first message transmission using one of the N time resources. N may be a natural number. For example, N may be 1 or 2. The reader may deliver information indicating N to the device through signaling. The reader may deliver the information indicating N using one bit.

The device may identify, through the random access indication, the number N of time resources available for first message transmission. The device may identify, through the random access indication, a time duration length T4 of each of the time resources available for first message transmission. Alternatively, T4 may indicate a time duration length from a start time of an N-th time resource available for first message transmission to a start time of an (N+1)-th time resource available for first message transmission.

The time resources available for first message transmission by the device may exist after a predetermined time duration from a transmission end time of the random access indication of the reader. The device may identify, based on the random access indication, a time duration length T3 from the transmission end time of the random access indication to a start time of the time resources available for first message transmission. T3 may indicate a time duration length from the transmission end time of the random access indication to a start time of the first time resource available for first message transmission.

The time duration length may be indicated in units of a chip length used in the communication system. The chip length may indicate a length of one symbol used in a line code or a length of a duration indicating one ON or OFF. For example, the chip length may indicate a length of a chip used for R2D transmission, which is transmission of the random access indication. As another example, the chip length may indicate a length of a chip used for performing D2R transmission (e.g., first message transmission) of the device based on the random access indication.

The reader may determine a resource position (e.g., a position of a time resource) at which first message transmission is performed, based on the above-described method (e.g., the method according to the exemplary embodiment of FIG. 14), and may receive the first message in the determined resource.

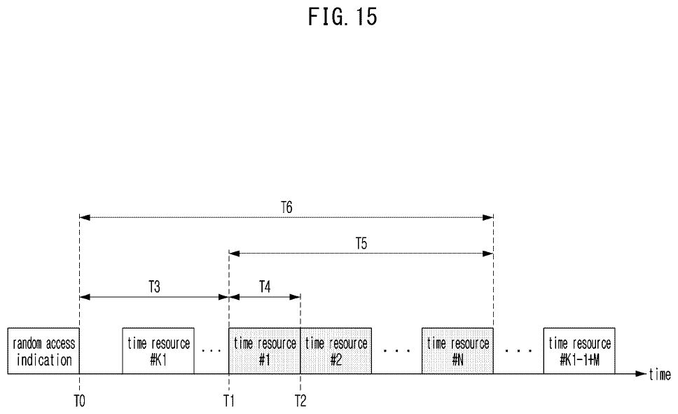

FIG. 15 is a conceptual diagram illustrating time resource configuration for first message transmission by a device.

Referring to FIG. 15, a reader may transmit a random access indication to a device. The device may receive the random access indication from the reader. The device may identify time resources available for first message transmission based on the random access indication. The time resources available for first message transmission may be M time resources (e.g., time resource #K1 to time resource #(K1−1+M)). The reader may indicate, to the device, N time resources (e.g., time resource #1 to time resource #N) available for first message transmission among M time resources. The N time resources may be indicated by the random access indication. Each of K1, M, and N may be a natural number.

To indicate the N time resources, the reader may transmit one or more of the following information items to the device.
Time duration length T3 from a transmission end time of the random access indication to a start time of time resources available for first message transmission
Time duration length T4 of one time resource among the time resources available for first message transmission
Number N of time resources available for first message transmission
Time duration length T6 from the transmission end time of the random access indication to an end time of time resources available for first message transmission
Total time duration length T5 of time resources available for first message transmission

The device may receive the one or more information items from the reader, and may identify the time resources available for first message transmission based on the one or more information items.

A maximum number M of time resources available for first message transmission by the device may be predefined. The reader may indicate, to the device, a number N of time resources that is equal to or less than the maximum number M of time resources available for first message transmission. The N time resources indicated by the reader may be available for first message transmission.

The N time resources available for first message transmission by the device may be consecutive in the time domain. For example, among the M time resources, the N time resources available for first message transmission may be consecutive in the time domain. The N time resources available for first message transmission may be determined as N time resources having earliest time indexes among the M time resources. Alternatively, the N time resources available for first message transmission may be determined as N time resources having latest time indexes among the M time resources.

The device may perform first message transmission using one of the N time resources available for first message transmission indicated through the random access indication. The device may arbitrarily select one time resource among the N time resources and may perform first message transmission using the selected one time resource. When N is 1, the device may perform first message transmission using the determined time resource.

A transmission time of the first message may vary depending on a number of time resources available for first message transmission. For example, a transmission time of the first message when the number of time resources available for first message transmission is 1 may be different from a transmission time of the first message when the number of time resources available for first message transmission exceeds 1.

Based on the fact that the number of time resources available for first message transmission is 1, the transmission time of the first message may be determined to be between a time T1 and a time T2. The time T1 may be a minimum required time from a reception time of the random access indication to a time at which the device performs first message transmission. The time T2 may be a maximum required time from the reception time of the random access indication to the time at which the device performs first message transmission. T1 or T2 may be a value predefined in the communication system. Alternatively, T1 or T2 may be a value indicated from the reader to the device. The device may transmit the first message between T1 and T2. For example, the device may start transmission of the first message between T1 and T2. The device may start and end transmission of the first message between T1 and T2.

Based on the fact that the number of time resources available for first message transmission exceeds 1, the first message may be transmitted at a specific time indicated by the reader. For example, the time indicated by the reader (e.g., a start time of a duration) may be after a time offset from the transmission end time of the random access indication. The time offset may be T3. T3 may be a time duration length from the transmission end time of the random access indication to a start time of time resources available for first message transmission. A time after the time offset from the transmission end time of the random access indication may be identical to or later than the time T1 described above.

For example, the time indicated by the reader (e.g., a start time of a duration) may be after a time offset from the transmission end time of the random access indication. The time offset may be T3+T4. T4 may be a time duration length from a start time of an N-th time resource available for first message transmission to a start time of an (N+1)-th time resource available for first message transmission. Alternatively, T4 may be a time duration length of one time resource among time resources available for first message transmission.

A transmission time of the first message may be differently set depending on whether the reader indicates the transmission time of the first message. For example, based on the fact that the reader indicates, to the device, the transmission time of the first message as being after the time offset T3 from the transmission end time of the random access indication, the device may transmit the first message at the time indicated by the reader (e.g., a time after the time offset T3 from the transmission end time of the random access indication). The time after the time offset T3 from the transmission end time of the random access indication may be identical to or later than T1 described above. Based on the fact that the reader does not indicate the transmission time of the first message, the device may transmit the first message between T1 and T2. T1 may be a minimum required time from a reception time of the random access indication to a time at which the device performs transmission of the first message. T2 may be a maximum required time from the transmission time of the random access indication to a time at which the device performs transmission of the first message. T1 or T2 may be a value predefined in the communication system. Alternatively, T1 or T2 may be a value indicated from the reader to the device. The device may transmit the first message between T1 and T2. For example, the device may start transmission of the first message between T1 and T2. Alternatively, the device may start and end transmission of the first message between T1 and T2.

The reader may indicate one or more time resources for PDRCH transmission to the device. The PDRCH may refer to a first message or a third message. For example, the reader may indicate one or two time resources for the PDRCH transmission to the device. The reader may allocate one or two time resources to the device according to a message type transmitted by the device through the PDRCH. Based on the fact that one time resource is indicated by the reader, the device may perform the PDRCH transmission using the one time resource. Based on the fact that two time resources are indicated, the device may arbitrarily select one time resource among the two time resources and may perform the PDRCH transmission using the selected time resource.

The reader may determine a resource position (e.g., a position of a time resource) in which transmission of the first message is performed, based on the above-described method (e.g., the method according to an exemplary embodiment of FIG. 15), and may receive the first message in the determined resource.

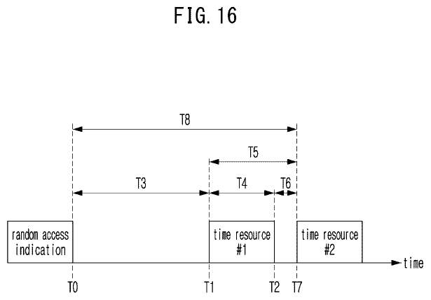

FIG. 16 is a conceptual diagram illustrating time resource configuration for first message transmission by a device.

Referring to FIG. 16, a reader may transmit a random access indication to a device. The device may receive the random access indication from the reader. The device may identify time resources available for first message transmission based on the random access indication. The time resources available for first message transmission may be composed of one or more time resources. For example, the time resources available for first message transmission may be composed of two time resources (e.g., time resource #1 and time resource #2). The device may perform first message transmission using time resource #1 or time resource #2. Alternatively, the device may repeatedly transmit the first message using time resource #1 and time resource #2.

The reader may indicate, to the device, a number of time resources used for PDRCH transmission. The PDRCH transmission may refer to transmission of the first message or the third message. The reader may indicate the number of time resources to the device using one bit. The number of time resources may be included in PDRCH scheduling information, and the reader may transmit the PDRCH scheduling information to the device.

The reader may indicate, to the device, positions of one or more time resources for the PDRCH transmission. A position of the first time resource among the positions of the one or more time resources may be indicated as a time offset T3 from an end time TO of a PRDCH for transmitting the PDRCH scheduling information. The time offset T3 may be defined as a ‘first time offset’. The PRDCH may refer to the second message or the random access indication.

An end time of the PRDCH may be a time at which transmission of last bit information of the PRDCH ends. The time at which transmission of the last bit information of the PRDCH ends may correspond to a bit immediately before a time at which the device confirms the PRDCH transmission end through detection of a postamble or an abnormal code of Manchester coding. Alternatively, the end time of the PRDCH may refer to an end time of R2D transmission including a postamble or an abnormal code of Manchester coding. Alternatively, when padding bits are transmitted to an OFDM symbol boundary after an end of the PRDCH transmission, a transmission end time of the PRDCH may be an end time of the padding bits. Alternatively, when padding bits are transmitted to the OFDM symbol boundary after the end of the PRDCH transmission, a transmission end time of the PRDCH may refer to an end time of a bit immediately before the padding bits.

The first time offset may be a value predefined in the communication system. The first time offset may vary according to a chip length used by the device for the PDRCH transmission, and the first time offset may be a value predefined in the communication system. Based on the fact that a chip length used for the PDRCH transmission is long (e.g., based on the fact that the chip length used for the PDRCH transmission is equal to or greater than a threshold), the first time offset may be defined as a large value (e.g., a large value among a plurality of preset values). Based on the fact that the chip length used for the PDRCH transmission is short (e.g., based on the fact that the chip length used for the PDRCH transmission is less than the threshold), the first time offset may be defined as a small value (e.g., a small value among the plurality of preset values). For example, based on the fact that the chip length used for the PDRCH transmission is equal to or greater than X, the first time offset may be defined as K. Based on the fact that the chip length used for the PDRCH transmission is less than Y, the first time offset may be defined as M. Each of X, K, Y, and M may be a natural number. X and Y may be the same value or different values. K may be greater than M.

As another exemplary embodiment, based on the fact that a chip length used for PRDCH transmission including the PDRCH scheduling information is long (e.g., based on the fact that the chip length used for the PRDCH transmission including the PDRCH scheduling information is equal to or greater than a threshold), the first time offset may be defined as a large value (e.g., a large value among a plurality of preset values). Based on the fact that the chip length used for the PRDCH transmission including the PDRCH scheduling information is short (e.g., based on the fact that the chip length used for the PRDCH transmission including the PDRCH scheduling information is less than the threshold), the first time offset may be defined as a small value (e.g., a small value among the plurality of preset values). For example, based on the fact that the chip length used for the PRDCH transmission including the PDRCH scheduling information is equal to or greater than X, the first time offset may be defined as K. Based on the fact that the chip length used for the PRDCH transmission including the PDRCH scheduling information is less than Y, the first time offset may be defined as M. Each of X, K, Y, and M may be a natural number. X and Y may be the same value or different values. K may be greater than M.

As another exemplary embodiment, based on the fact that the chip length used for the PDRCH transmission is relatively long (e.g., based on the fact that the chip length used for the PDRCH transmission is equal to or greater than a threshold), the first time offset may be defined according to the chip length used for the PDRCH transmission. Based on the fact that the chip length used for the PDRCH transmission is relatively short (e.g., based on the fact that the chip length used for the PDRCH transmission is less than the threshold), the first time offset may be defined according to the chip length used for PRDCH transmission including the PDRCH scheduling information. For example, based on the fact that the chip length used for the PDRCH transmission is equal to or greater than X, the first time offset may be determined according to the chip length used for the PDRCH transmission. Based on the fact that the chip length used for the PDRCH transmission is equal to or greater than Y, the first time offset may be K. Based on the fact that the chip length used for the PDRCH transmission is less than Z, the first time offset may be L. Based on the fact that the chip length used for the PDRCH transmission is less than X, the first time offset may be determined according to the chip length used for the PRDCH transmission including the PDRCH scheduling information. For example, based on the fact that the chip length used for the PRDCH transmission including the PDRCH scheduling information is equal to or greater than W, the first time offset may be A. Based on the fact that the chip length used for the PRDCH transmission including the PDRCH scheduling information is less than W, the first time offset may be B. For example, X may be 4.17 μs, W may be 33.33 μs, and W may be eight times X.

As another exemplary embodiment, the reader may indicate a value of the first time offset to the device. The reader may transmit, to the device, PDRCH scheduling information including information indicating the first time offset. The device may receive the PDRCH scheduling information from the reader, and may identify the information indicating the first time offset included in the PDRCH scheduling information. As another exemplary embodiment, the first time offset may be determined based on a message type of the PRDCH transmitted by the reader or a message type of the PDRCH transmitted by the device.

The reader may indicate, to the device, positions of one or more time resources for PDRCH transmission. For example, among the positions of the one or more time resources, a position of the second time resource may be indicated as a time offset T8 from an end time TO of the PRDCH including the PDRCH scheduling information.

The time offset T8 may be determined based on a combination of the first time offset T3 from the end time T0 of the PRDCH to the start time T1 of the first time resource and a length T4 of the PDRCH transmitted in the first time resource. The length T4 of the PDRCH transmitted in the first time resource may be a time (e.g., a length) of the PDRCH transmission indicated by the PDRCH scheduling information. The length T4 of the PDRCH transmitted in the first time resource may be determined based on a product of a number of chips transmitted through the PDRCH and a chip length used for the PDRCH transmission. The time offset T8 may be determined by multiplying, by a constant, a sum of the first time offset T3 and the length T4 of the PDRCH transmitted in the first time resource. For example, the time offset T8 may be defined as shown in Equation 3 below.

$$T = C \times ( O + L ) \qquad [ Equation 3 ]$$

In Equation 3, T may indicate the time offset T8. O may indicate the first time offset T3 from the end time of the PRDCH to the start time of the first time resource. L may indicate the length T4 of the PDRCH transmitted in the first time resource. C may be a constant value including a time buffer (e.g., a length of the time buffer). In other words, the constant value may be a value corresponding to the length of the time buffer or a value in which the length of the time buffer is reflected. C may be 1 or greater. For example, C may be 1.25.

As another exemplary embodiment, among the positions of the one or more time resources, the position of the second time resource may be indicated by a time offset T5 or T6 from the position of the first time resource. The device may receive, from the reader, information indicating the first time offset, and may identify the position of the first time resource based on the information indicating the first time offset. The device may receive, from the reader, the time offset T5 or T6 from the position of the first time resource to the position of the second time resource. The device may identify the position of the second time resource by using a transmission end time of the PRDCH including the PDRCH scheduling information, the time offset T5 or T6, and the first time offset T3.

The time offset T5 may indicate a time interval from the start time of the first time resource to the start time of the second time resource. The time offset T5 may be defined as a ‘second time offset’. The time offset T6 may indicate a time interval from an end time of the first time resource to the start time of the second time resource. The time offset T6 may be defined as a ‘third time offset’. The device may determine the end time of the first time resource based on the start time of the first time resource and the length of the PDRCH transmitted in the first time resource.

The second time offset and/or the third time offset may be predefined in the communication system. Alternatively, the reader may indicate the second time offset and/or the third time offset to the device. The reader may transmit, to the device, PDRCH scheduling information including information indicating the second time offset T5 and/or information indicating the third time offset T6. The device may receive the PDRCH scheduling information from the reader. The device may identify the second time offset and/or the third time offset through the PDRCH scheduling information. Alternatively, the second time offset and/or the third time offset may be determined based on a message type of the PRDCH transmitted by the reader or a message type of the PDRCH transmitted by the device.

The first time offset, the second time offset, and/or the third time offset may be indicated in a time unit used for PRDCH transmission including the PDRCH scheduling information. For example, a transmission time of the PDRCH may be indicated based on a length of a modulation symbol or a chip period of a line code used for the PRDCH transmission.

As another exemplary embodiment, the first time offset, the second time offset, and/or the third time offset may be indicated in a time unit used for the PDRCH transmission. For example, the transmission time of the PDRCH may be indicated based on a length of a modulation symbol or a chip period of a line code used for the PDRCH transmission.

As another exemplary embodiment, the first time offset, the second time offset, and/or the third time offset may be indicated based on a minimum time unit supported by the communication system. For example, the transmission time of the PDRCH may be indicated by using a minimum length of a modulation symbol or a minimum chip period of a line code used for PRDCH transmission or PDRCH transmission. The minimum length of the modulation symbol or the minimum chip period of the line code may vary based on a value of M supported for the OOK-4(M) modulation scheme in the communication system. The minimum time unit may be derived based on the length of the modulation symbol or the chip period of the line code when a maximum value of M supported in the OOK-M modulation scheme is used.

As another exemplary embodiment, the first time offset, the second time offset, and/or the third time offset may be indicated based on a PRDCH length or a PDRCH length. For example, the transmission time of the PDRCH may be indicated in units of a time length of a PRDCH scheduling the PDRCH. Alternatively, the transmission time of the PDRCH may be indicated in units of a time length of the PDRCH scheduled by the PRDCH.

As another exemplary embodiment, the first time offset, the second time offset, and/or the third time offset may be indicated in units of an OFDM symbol length of the communication system (e.g., NR system). Alternatively, the first time offset, the second time offset, and/or the third time offset may be indicated in an absolute time unit (e.g., μs).

The device may transmit a device ID through the first message. The device ID may be a randomly generated ID. The device ID may be composed of X bits. For example, X may be 16. The device ID composed of X bits may be generated based on an index of a transmission time resource of the first message. In a process of generating the device ID, an index of a time resource in which the device transmits the first message may be used.

The reader may determine a resource position (e.g., a position of a time resource) in which transmission of the first message is performed, based on the above-described method (e.g., the method according to the exemplary embodiment of FIG. 16), and may receive the first message in the determined resource.

Frequency resources available for first message transmission by the device may be indicated to the device through the random access indication of the reader. The reader may transmit, to the device, the random access indication including information regarding the frequency resources available for first message transmission. The device may receive the random access indication from the reader, and may identify the information regarding the frequency resources available for first message transmission included in the random access indication. The information regarding the frequency resources available for first message transmission may include one or more of the following information items.
Index(es) of a frequency resource available for first message transmission
Information of a line code available for first message transmission
Number of frequency resources available for first message transmission

The device may perform first message transmission in a predetermined frequency resource by using characteristics of the line code. For example, when the device desires to transmit the first message by using repeated transmission of the line code, the device may transmit the first message in a frequency resource determined in consideration of the repeated transmission characteristic of the line code. The device may identify, through the random access indication, the information of the line code available for first message transmission, and may identify information on frequency resources available for first message transmission based on the information of the available line code.

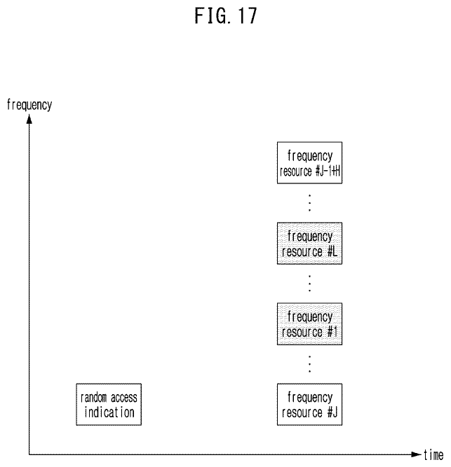

FIG. 17 is a conceptual diagram illustrating frequency resource configuration for first message transmission by a device.

Referring to FIG. 17, a reader may transmit a random access indication to a device. The device may receive the random access indication from the reader. The device may identify frequency resources available for first message transmission based on the random access indication. The frequency resources available for first message transmission may be H frequency resources (e.g., frequency resource #J to frequency resource #(J−1+H)). The reader may indicate, to the device, L frequency resources (e.g., frequency resource #1 to frequency resource #L) available for first message transmission among the H frequency resources. The indication of the L frequency resources may be included in the random access indication. The device may identify information of the L frequency resources included in the random access indication. Each of J, H, and L may be a natural number.

In the communication system, the maximum number H of frequency resources available for first message transmission by the device may be predefined. The reader may indicate, to the device, L frequency resources that are equal to or less than the maximum number H of frequency resources available for first message transmission, and the device may transmit a first message by using the L frequency resources indicated by the reader.

The L frequency resources available for first message transmission by the device may be consecutive in the frequency domain. Among the H frequency resources, the L frequency resources available for first message transmission may be consecutive in the frequency domain. Among the H frequency resources, the L frequency resources available for first message transmission may be determined as L frequency resources having lowest starting subcarrier indexes. Alternatively, among the H frequency resources, the L frequency resources available for first message transmission may be determined as L frequency resources having highest starting subcarrier indexes.

The device may perform first message transmission by using one frequency resource among the L frequency resources available for first message transmission indicated by the random access indication. The device may arbitrarily select one frequency resource among the L frequency resources and may perform first message transmission by using the selected one frequency resource. Based on the fact that L is 1, the device may perform first message transmission by using the determined frequency resource.

The reader may indicate a data transmission rate of the first message of the device performing random access. The device may perform first message transmission based on the data transmission rate indicated by the reader. For example, the reader may indicate an identical data transmission rate (e.g., a common data transmission rate) for a plurality of devices or an independent data transmission rate for each device based on a random access type. Based on the fact that FDMA is applied to first message transmission, the reader may indicate an identical data transmission rate for a plurality of devices transmitting the first messages at the same time or an independent data transmission rate for each of the plurality of devices based on the random access type. Based on the fact that FDMA is applied to first message transmission based on the random access type (e.g., CBRA or CFRA), the reader may indicate an identical data transmission rate for the plurality of devices or an independent data transmission rate for each device.

Based on the fact that the random access type is CBRA and FDMA is applied to first message transmission, the reader may equally set data transmission rates of first messages transmitted by a plurality of devices at the same time. Based on the fact that the random access type is CFRA and FDMA is applied to first message transmission, the reader may independently set a data transmission rate of a first message transmitted by each of the plurality of devices at the same time.

The device may transmit a device ID through the first message. In other words, the device ID may be included in the first message. The device ID may be a randomly generated ID. The device ID may be composed of X bits. For example, X may be 16. The device ID composed of X bits may be determined based on an index of a frequency resource in which the device transmits the first message. For example, an index of a frequency resource in which the device transmits the first message may be used in a process of generating the device ID.

The reader may determine a resource position (e.g., a position of a frequency resource) in which transmission of the first message is performed, based on the above-described method (e.g., the method according to an exemplary embodiment of FIG. 17), and may receive the first message in the determined resource.

Time resources available for first message transmission may be indicated to the device through the random access indication of the reader. The reader may indicate, to the device, N time resources (e.g., time resource #1 to time resource #N) available for first message transmission among M time resources. The indication of the N time resources may be transmitted through the random access indication.

To indicate the N time resources, the reader may transmit, to the device, one or more of the following information items.
Time duration length from a transmission end time of the random access indication to a start time of time resources available for first message transmission
Time duration length from the transmission end time of the random access indication to a start time of the first time resource available for first message transmission
Time duration length from the transmission end time of the random access indication to a start time of the second time resource available for first message transmission
Time duration length from the start time of the first time resource available for first message transmission to the start time of the second time resource available for first message transmission
Time duration length from an end time of the first time resource available for first message transmission to the start time of the second time resource available for first message transmission
Time duration length of one time resource among time resources available for first message transmission
Number of time resources available for first message transmission

Frequency resources available for first message transmission by the device may be indicated to the device through the random access indication of the reader. The reader may indicate, to the device, L frequency resources available for first message transmission among H frequency resources. Information indicating the L frequency resources may be transmitted through the random access indication.

To indicate the L frequency resources, the reader may transmit, to the device, one or more of the following information items.
Index(es) of frequency resources available for first message transmission
Information of a line code available for first message transmission
Number of frequency resources available for first message transmission

Based on the random access indication, N×L transmission resources composed of N resources in the time domain and L resources in the frequency domain may be indicated to the device. The device may perform first message transmission by using one transmission resource among the N×L transmission resources. The device may arbitrarily select one transmission resource among the N×L transmission resources and may perform transmission of the first message by using the selected transmission resource.

The device may transmit a device ID through the first message. In other words, the first message may include the device ID. The device ID may be a randomly generated ID. The device ID may be composed of X bits. For example, X may be 16. The device ID composed of X bits may be determined based on an index of a transmission resource (e.g., a time resource and/or a frequency resource) in which the device transmits the first message. For example, an index of a time resource and/or an index of a frequency resource in which the device transmits the first message may be used in a process of generating the device ID.

In the communication system, the device may transmit the first message to the reader. The reader may receive the first message from the device. The reader may receive the first message from each of one or more devices. Based on the fact that the first message is received from the device, the reader may transmit a second message to the device. The device may receive the second message from the reader.

The second message may include information of a device ID obtained through the first message. The second message may include scheduling information for transmission of a third message of the device.

The reader may transmit a random access indication to one or more devices. Each of the one or more devices receiving the random access indication may transmit a first message to the reader. For example, the reader may receive N first messages from one or more devices. N may be a natural number.

The reader that receives one or more first messages may transmit one or more second messages. For example, the reader that receives N first messages may transmit N second messages. One first message and one second message may have a corresponding relationship with each other. For example, the reader may transmit a second message #1 corresponding to a first message #1 received from a device #1 to the device #1. The second message #1 may include ID information of the device #1. The ID information of the device #1 may be identical to a device ID included in the first message #1. The second message #1 may include scheduling information for transmission of a third message of the device #1. The reader may transmit a second message #2 corresponding to a first message #2 received from a device #2 to the device #2. The second message #2 may include ID information of the device #2. The ID information of the device #2 may be identical to a device ID included in the first message #2. The second message #2 may include scheduling information for transmission of a third message of the device #2. The second message #1 and the second message #2 may be transmitted individually.

As another exemplary embodiment, the reader that receives one or more first messages may transmit one second message. For example, the reader that receives N first messages may transmit one second message. The N first messages and the one second message may have a corresponding relationship with each other. For example, the reader may transmit a second message #1 corresponding to a first message #1 received from a device #1 and a first message #2 received from a device #2. The second message #1 may include information corresponding to the first message #1 and information corresponding to the first message #2. The information corresponding to the first message #1 and the information corresponding to the first message #2 may be sequentially located within the second message #1.

The information corresponding to the first message #1 may include ID information of the device #1. The ID information of the device #1 may be identical to a device ID included in the first message #1. The information corresponding to the first message #1 may include scheduling information for transmission of a third message of the device #1. The information corresponding to the first message #2 may include ID information of the device #2. The ID information of the device #2 may be identical to a device ID included in the first message #2. The information corresponding to the first message #2 may include scheduling information for transmission of a third message of the device #2.

One second message may include information corresponding to a maximum of M first messages. M may be predefined in the communication system. In the communication system, M may have a value identical to N. Alternatively, in the communication system, M may have a value smaller than N. The reader may transmit one or more second messages in order to transmit second messages corresponding to N first messages. For example, among the second messages corresponding to the N first messages, M second messages may be transmitted through a second message resource #1. Among the second messages corresponding to the N first messages, (N-M) second messages may be transmitted through a second message resource #2.

Allocation of the second message resource #1 or the second message resource #2 may vary based on a resource through which a first message is transmitted (e.g., a time resource and/or a frequency resource). For example, a second message corresponding to an early first message in the time domain may be transmitted in the second message resource #1. A second message corresponding to a late first message in the time domain may be transmitted in the second message resource #2. For example, a second message corresponding to a first message having a low resource index in the frequency domain may be transmitted in the second message resource #1. A second message corresponding to a first message having a high resource index in the frequency domain may be transmitted in the second message resource #2. Alternatively, a second message corresponding to a first message having a high resource index in the frequency domain may be transmitted in the second message resource #1. A second message corresponding to a first message having a low resource index in the frequency domain may be transmitted in the second message resource #2.

The device that transmits a first message may receive a second message from the reader. The device may perform second message monitoring in order to receive the second message from the reader.

The device may perform first message transmission. The reader that receives the first message from the device may perform second message transmission corresponding to the first message. The device may perform signal monitoring for reception of the second message. The device may perform second message monitoring (e.g., second message signal monitoring) after a time offset from a transmission time of the first message. The device may not perform second message monitoring before the time offset elapses from the transmission time of the first message. The reader may perform second message transmission after a time offset from a reception time of the first message. The reader may not perform second message transmission before the time offset elapses from the reception time of the first message.

The device may perform second message monitoring during a time duration (e.g., a preconfigured time duration). The time duration may be referred to as a second message monitoring duration. The device may not perform second message monitoring during a time duration other than the second message monitoring duration. When the device fails to receive a second message during the second message monitoring duration, the device may determine that reception of the first message at the reader has failed.

The reader may transmit information on the second message monitoring duration to the device. The device may receive the information on the second message monitoring duration from the reader. The information on the second message monitoring duration may be transmitted through a random access indication. The information on the second message monitoring duration may include one or more of the following information items.
Information on a start time of the second message monitoring duration
Information on a length (duration) of the second message monitoring duration
Information on an end time of the second message monitoring duration

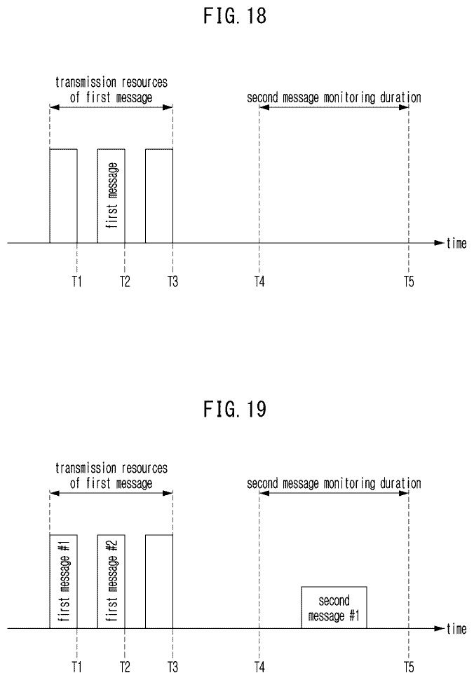

FIG. 18 is a conceptual diagram illustrating a second message monitoring duration.

Referring to FIG. 18, a device may transmit a first message by using one of first message transmission resources. The device that has transmitted the first message may determine a second message monitoring duration for performing signal monitoring in order to receive a second message from the reader. The device may perform second message monitoring during the second message monitoring duration.

A start time of the second message monitoring duration may be indicated by a time offset from a reference point. The reference point for determining the start time of the second message monitoring duration may be an end time of a time resource in which the device transmitted the first message. For example, the reference point for determining the start time of the second message monitoring duration may be T2. As another exemplary embodiment, the reference point for determining the start time of the second message monitoring duration may be an end time of a transmission resource that is latest in the time domain among transmission resources available for first message transmission. For example, the reference point for determining the start time of the second message monitoring duration may be T3. As another exemplary embodiment, the reference point for determining the start time of the second message monitoring duration may be an end time of an R2D transmission including a random access indication of the reader.

The reference point for determining the start time of the second message monitoring duration of the device may be determined according to a number of time resources for first message transmission. For example, based on the number of time resources for first message transmission being one, the reference point for determining the start time of the second message monitoring duration of the device may be an end time of the time resource in which the device transmitted the first message. Based on the number of time resources for first message transmission being greater than one, the reference point for determining the start time of the second message monitoring duration of the device may be an end time of a resource that is latest in the time domain among transmission resources available for first message transmission.

The start time of the second message monitoring duration of the device may be indicated by a time offset from the reference point. The time offset may be indicated in units of a chip length used for R2D transmission. For example, the time offset may be indicated (e.g., configured) in units of a chip length of a line code used for transmission of the random access indication of the reader. The time offset may be indicated in units of a chip length used for D2R transmission. For example, the time offset may be indicated (e.g., configured) in units of a chip length of a line code used for first message transmission by the device. When a line code is not used for first message transmission, the chip length may be a length of one modulation symbol. In the exemplary embodiment of FIG. 18, the device may determine the start time T4 of the second message monitoring duration based on the above-described indication.

A length (e.g., time) of the second message monitoring duration may be a predefined value. As another exemplary embodiment, the length of the second message monitoring duration may be indicated by the random access indication. As another exemplary embodiment, a default value for the length of the second message monitoring duration may be predefined. The device may receive length information of the second message monitoring duration from the reader, and the device may determine the length of the second message monitoring duration based on the received length information. Based on the device failing to receive the length information of the second message monitoring duration from the reader, the device may determine the length of the second message monitoring duration by using a predefined default value. The length of the second message monitoring duration may be indicated in units of a chip length used for R2D transmission. For example, the length of the second message monitoring duration may be indicated in units of a chip length of a line code used for transmission of the random access indication of the reader. The length of the second message monitoring duration may be indicated in units of a chip length used for D2R transmission. For example, the length of the second message monitoring duration may be indicated in units of a chip length of a line code used for transmission of the first message of the device. Based on a line code not being used for transmission of the first message, the chip length may be a length of one modulation symbol. The device may determine the length of the second message monitoring duration based on the above-described indication, and the device may determine an end time T5 of the second message monitoring duration based on T4 and the length of the second message monitoring duration.

The device may identify the second message monitoring duration based on the above-described information. In the exemplary embodiment of FIG. 18, the device may perform second message monitoring in a duration (e.g., the second message monitoring duration) between T4 and T5.

When the reader receives N first messages from one or more devices, configuration of the second message monitoring duration may vary based on a transmission scheme of the second message.

N devices may transmit N first messages. The reader that has received the N first messages may transmit one second message. The second message may include information corresponding to the N first messages. In the above-described situation, the second message monitoring duration may be identically determined for the N devices. A start time of the second message monitoring duration may be indicated by a time offset from a reference point. The reference point for determining the start time of the second message monitoring duration may be an end time of a transmission resource that is latest in the time domain among transmission resources available for first message transmission. The N devices may perform second message monitoring in the same second message monitoring duration.

FIG. 19 is a conceptual diagram illustrating a second message monitoring duration.

Referring to FIG. 19, a device #1 may transmit a first message #1 by using a transmission resource for first message transmission. A device #2 may transmit a first message #2 by using a transmission resource for first message transmission. The reader may receive the first message #1 from the device #1 and may receive the first message #2 from the device #2. The reader may transmit one second message (e.g., a second message #1) corresponding to the first message #1 and the first message #2. The reader may indicate the same second message monitoring duration to the device #1 and the device #2. A reference point for determining a start time of the second message monitoring duration may be an end time of a transmission resource that is latest in the time domain among transmission resources available for first message transmission. In the exemplary embodiment of FIG. 19, the reference point may be T3. The device #1 and the device #2 may perform second message monitoring in the same second message monitoring duration.

N devices may transmit N first messages. The reader that has received the N first messages may transmit N second messages. One second message may include information corresponding to one first message. In the above-described situation, the second message monitoring duration may be identically determined for the N devices. A start time of the second message monitoring duration may be indicated by a time offset from a reference point. The reference point for determining the start time of the second message monitoring duration may be an end time of a resource that is latest in the time domain among transmission resources available for first message transmission. The N devices may perform second message monitoring in the same second message monitoring duration.

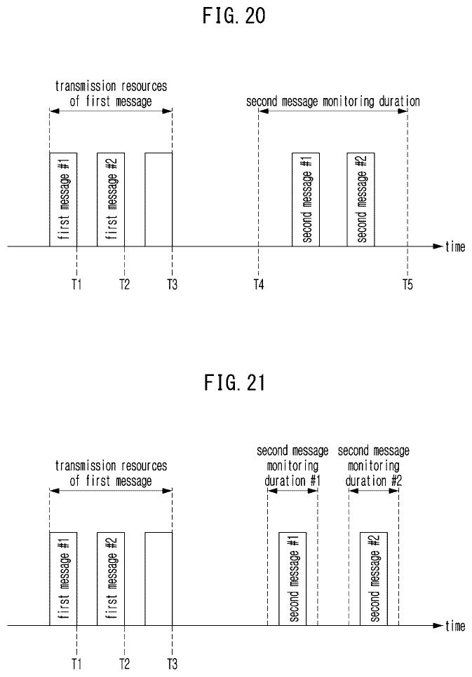

FIG. 20 is a conceptual diagram illustrating a second message monitoring duration.

Referring to FIG. 20, a device #1 may transmit a first message #1 by using a transmission resource for first message transmission. A device #2 may transmit a first message #2 by using a transmission resource for first message transmission. The reader may receive the first message #1 from the device #1 and may receive the first message #2 from the device #2. The reader may transmit a second message #1 corresponding to the first message #1 and a second message #2 corresponding to the first message #2. The reader may indicate the same second message monitoring duration to the device #1 and the device #2. A reference point for determining a start time of the second message monitoring duration may be an end time of a resource that is latest in the time domain among transmission resources available for first message transmission. In the exemplary embodiment of FIG. 20, the reference point may be T3. The device #1 and the device #2 may perform second message monitoring in the same second message monitoring duration.

N devices may transmit N first messages. The reader that has received the N first messages may transmit N second messages. One second message may include information corresponding to one first message. In the above-described situation, the second message monitoring duration may be individually determined (e.g., configured) for the N devices. A start time of the second message monitoring duration may be indicated by a time offset from a reference point. The reference point for determining the start time of the second message monitoring duration may be an end time of a time resource in which each first message is transmitted. Each of the N devices may perform second message monitoring in an individual second message monitoring duration.

FIG. 21 is a conceptual diagram illustrating a second message monitoring duration.

Referring to FIG. 21, a device #1 may transmit a first message #1 by using a transmission resource for first message transmission. A device #2 may transmit a first message #2 by using a transmission resource for first message transmission. A reader may receive the first message #1 from the device #1 and may receive the first message #2 from the device #2. The reader may transmit a second message #1 corresponding to the first message #1 and a second message #2 corresponding to the first message #2. The reader may indicate individual second message monitoring durations to the device #1 and the device #2. The device #1 may determine a second message monitoring duration #1 based on the indication of the reader. The device #2 may determine a second message monitoring duration #2 based on the indication of the reader. A reference point for determining a start time of the second message monitoring duration may be an end time of a time resource in which each device transmitted the first message. In the exemplary embodiment of FIG. 21, the reference point of the device #1 may be T1, and the reference point of the device #2 may be T2. The device #1 may perform second message monitoring in the second message monitoring duration #1. The device #2 may perform second message monitoring in the second message monitoring duration #2.

The device may transmit a first message to the reader. The device may receive a second message from the reader after transmission of the first message. Based on the device failing to receive the second message from the reader after transmission of the first message, the device may determine that transmission of the first message has failed. A reception time of the second message for determining a failure of transmission of the first message may be defined. When the device fails to receive the second message from a transmission time of the first message until reception of a random access trigger message of the reader, the device may determine that transmission of the first message has failed. The random access trigger message may be a random access trigger message transmitted from the reader after transmission of the first message of the device. As another exemplary embodiment, when the device fails to receive the second message from the transmission time of the first message until reception of a paging message of the reader, the device may determine that transmission of the first message has failed. The paging message may be a paging message transmitted from the reader after transmission of the first message of the device. As another exemplary embodiment, when the device fails to receive the second message from the transmission time of the first message until reception of K random access trigger messages of the reader, the device may determine that transmission of the first message has failed. K may be a natural number. The K random access trigger messages may be K random access trigger messages transmitted from the reader after transmission of the first message of the device. K may be a predefined value in the communication system. Alternatively, the reader may indicate a value of K to the device. The value of K may be included in a paging message. A range of K may be predefined in the communication system.

Based on the second message being received before a reception time of the second message, the device may perform third message transmission. When the device receives the second message after the reception time of the second message, or when the device fails to receive the second message, the device may determine that transmission of the first message has failed.

The reader may receive the first message from the device, may identify a device ID included in the first message, and may transmit a second message including an ID (hereinafter referred to as an “echo ID”) identical to the device ID to the device. The device may receive the second message from the reader and may identify the ID (e.g., echo ID) included in the second message. Based on the echo ID obtained through the second message being identical to the device ID included in the first message, the device may determine that transmission of the first message has succeeded.

The reader may transmit, to the device, an index of a frequency resource in which the first message including the device ID is received. The index of the frequency resource in which the first message is received may be included in the second message transmitted by the reader. The second message may include information indicating whether the index of the frequency resource in which the first message is received is included in the second message. The device may receive the second message from the reader and may identify whether the second message includes the index of the frequency resource based on the information included in the second message. When the index of the frequency resource in which the first message is received is not included in the second message and/or when the echo ID obtained through the second message is identical to the device ID included in the first message, the device may determine that transmission of the first message has succeeded.

When the index of the frequency resource in which the first message is received is included in the second message, the echo ID obtained through the second message is identical to the device ID included in the first message, and the index of the frequency resource in which the first message is received obtained through the second message is identical to a frequency resource index of the first message transmitted by the device, the device may determine that transmission of the first message of the device has succeeded. When the index of the frequency resource in which the first message is received is included in the second message, and the echo ID obtained through the second message is different from the device ID included in the first message, or when the index of the frequency resource in which the first message is received is included in the second message, and the index of the frequency resource in which the first message is received obtained through the second message is different from the frequency resource index of the first message transmitted by the device, the device may determine that transmission of the first message has failed.

The device that has received a second message from the reader may transmit a third message to the reader. Scheduling information for transmission of the third message may include information (e.g., parameters) on environment variables used for transmission of the third message. The scheduling information for transmission of the third message may include one or more of the following information items.
Modulation scheme
Line code information
FEC information
TB size
Time resource information
Frequency resource information
ID information
Repeated transmission information
MCS information
Midamble information

A part of scheduling information for third message transmission may be transmitted through a physical layer message. Apart of scheduling information for third message transmission may be transmitted through a higher layer message. The part of the scheduling information may be information commonly applied to scheduling of the second message and scheduling of the third message. For example, ID information of a device receiving the second message and ID information of a device receiving the scheduling information for transmission of the third message may be information commonly applied to scheduling of the second message and scheduling of the third message. The ID information may be included in scheduling information of the second message or scheduling information of the third message, and the ID information may be used for scheduling of the second message and scheduling of the third message. For example, the ID information may be transmitted by being included in the scheduling information of the second message, and the ID information may be used for scheduling of the second message and scheduling of the third message. The ID information may be transmitted through a physical layer message. Alternatively, the ID information may be transmitted through a higher layer message.

The reader may indicate, to the device, a time resource and/or a frequency resource for third message transmission by the device. The reader may transmit, to the device, a second message including information indicating the time resource and/or the frequency resource for third message transmission. The device may receive the second message from the reader and may identify the time resource and/or the frequency resource for third message transmission based on the information included in the second message.

The information of the time and frequency resource for third message transmission may be transmitted through the second message. The device may identify the time and frequency resources for third message transmission based on the information obtained through the second message. The device may transmit a third message to the reader by using the time and frequency resources.

As another exemplary embodiment, time resource information for third message transmission may be transmitted through the second message. The device may identify a time resource for third message transmission based on information obtained through the second message. The device may use, as a frequency resource for third message transmission, a frequency resource used for transmission of the first message. For example, based on the second message not indicating a frequency resource for third message transmission, the device may use, as a frequency resource for third message transmission, the frequency resource used for transmission of the first message. The device may transmit a third message by using the frequency resource used for transmission of the first message and the time resource indicated by the second message.

When time resource information for third message transmission by the device is transmitted through the second message, an indication of the time resource may be indicated in units of a chip length used for R2D transmission. For example, the indication of the time resource may be indicated in units of a chip length of a line code used for transmission of the second message of the reader. The indication of the time resource may be indicated in units of a chip length used for D2R transmission. For example, the indication of the time resource may be indicated in units of a chip length of a line code used for transmission of the third message of the device. When a line code is not used for transmission of the third message, the chip length may be a length of one modulation symbol. The time resource may be indicated by one or more of a start position of the time resource, an end position of the time resource, or a length of the time resource.

When time resource information for third message transmission by the device is transmitted through the second message, a length of the time resource may be indicated as a multiple of a length of a time resource used for transmission of the first message. For example, based on the length of the time resource used for transmission of the first message being T, the length of the time resource for transmission of the third message may be indicated as X times T. The device may determine the length of the time resource for transmission of the third message based on the length T of the time resource for transmission of the first message and X. Each of T and X may be a natural number.

As another exemplary embodiment, time and frequency resources for third message transmission may be identical to time and frequency resources used for transmission of the first message. The reader may not transmit, to the device, time and frequency resource information for third message transmission. In this case, the device may perform transmission of the third message by using time and frequency resources used for transmission of the first message. In other words, transmission of the first message and transmission of the third message may be performed by using the same time and frequency resources.

The reader may receive a first message from the device. The reader may transmit a second message to the device. The device may receive the second message from the reader and may perform D2R transmission (e.g., transmission of a third message). A time offset from an end time of the second message transmitted by the reader to a start time of the D2R transmission of the device (e.g., transmission of the third message) may be defined. The time offset may be defined as a ‘fourth time offset’. The device may perform D2R transmission after the time offset (e.g., the fourth time offset) from the end time of the second message transmitted by the reader.

The reader may indicate performance of CFRA to the device. Based on performance of CFRA being indicated from the reader, the device may perform D2R transmission. A time offset from an end time of the CFRA indication message of the reader to a start time of D2R transmission of the device may be defined. The time offset may be defined as a ‘fifth time offset’. The device may perform D2R transmission after the time offset (e.g., the fifth time offset) from the end time of the CFRA indication message transmitted by the reader.

The fourth time offset and the fifth time offset may be defined as the same value.

The fourth time offset and the fifth time offset may be predefined values in the communication system. The fourth time offset and the fifth time offset may vary based on a chip length used by the device for PDRCH transmission. Based on the chip length used for PDRCH transmission being long (e.g., based on the chip length used for PDRCH transmission being equal to or greater than a threshold), the fourth time offset and the fifth time offset each may be defined as a large value (e.g., a large value among a plurality of preset values). Based on the chip length used for PDRCH transmission being short (e.g., based on the chip length used for PDRCH transmission being less than a threshold), the fourth time offset and the fifth time offset each may be defined as a small value (e.g., a small value among the plurality of preset values). For example, based on the chip length used for PDRCH transmission being equal to or greater than X, the fourth time offset and the fifth time offset may be defined as K. Based on the chip length used for PDRCH transmission being less than Y, the fourth time offset and the fifth time offset may be defined as M

As another exemplary embodiment, based on a chip length used for PRDCH transmission including PDRCH scheduling information being long (e.g., based on the chip length used for PRDCH transmission including the PDRCH scheduling information being equal to or greater than a threshold), the fourth time offset and the fifth time offset each may be defined as a large value (e.g., a large value among a plurality of preset values). Based on the chip length used for PRDCH transmission including the PDRCH scheduling information being short (e.g., based on the chip length used for PRDCH transmission including the PDRCH scheduling information being less than a threshold), the fourth time offset and the fifth time offset each may be defined as a small value (e.g., a small value among the plurality of preset values). For example, based on the chip length used for PRDCH transmission including the PDRCH scheduling information being equal to or greater than X, the fourth time offset and the fifth time offset may be defined as K. For example, based on the chip length used for PRDCH transmission including the PDRCH scheduling information being less than Y, the fourth time offset and the fifth time offset may be defined as M.

As another exemplary embodiment, based on the chip length used for PDRCH transmission being relatively long (e.g., based on the chip length used for PDRCH transmission being equal to or greater than a threshold), the fourth time offset and the fifth time offset may be defined according to the chip length used for PDRCH transmission. Based on the chip length used for PDRCH transmission being relatively short (e.g., based on the chip length used for PDRCH transmission being less than a threshold), the fourth time offset and the fifth time offset may be defined according to the chip length used for PRDCH transmission including PDRCH scheduling information. For example, based on the chip length used for PDRCH transmission being equal to or greater than X, the fourth time offset and the fifth time offset may be determined according to the chip length used for PDRCH transmission. For example, based on the chip length used for PDRCH transmission being equal to or greater than Y, the fourth time offset and the fifth time offset may be K. For example, based on the chip length used for PDRCH transmission being less than Z, the fourth time offset and the fifth time offset may be L. For example, based on the chip length used for PDRCH transmission being less than X, the fourth time offset and the fifth time offset may be determined according to the chip length used for PRDCH transmission including the PDRCH scheduling information. For example, based on the chip length used for PRDCH transmission including the PDRCH scheduling information being equal to or greater than W, the fourth time offset and the fifth time offset may be A. For example, based on the chip length used for PRDCH transmission including the PDRCH scheduling information being less than W, the fourth time offset and the fifth time offset may be B. For example, X may be 4.17 s, W may be 33.33 s, and W may be eight times X.

The fourth time offset and the fifth time offset may vary based on whether channel coding is applied to PDRCH in D2R transmission of a device. Based on the device applying channel coding to PDRCH (e.g., D2R transmission), the fourth time offset and the fifth time offset each may be defined as a large value (e.g., a large value among a plurality of preset values). When the device applies channel coding to PDRCH (e.g., D2R transmission), the fourth time offset and the fifth time offset may be determined by applying (e.g., adding) an additional time offset (=F) to a time offset when the device does not apply channel coding to PDRCH (e.g., D2R transmission). Whether to apply the additional time offset according to application of channel coding may be determined based on a chip length used for D2R transmission. For example, based on the chip length used for D2R transmission being long (e.g., based on the chip length used for D2R transmission being equal to or greater than a threshold), the additional time offset according to application of channel coding may not be applied. Based on the chip length used for D2R transmission being short (e.g., based on the chip length used for D2R transmission being less than a threshold), the additional time offset F according to application of channel coding may be applied. Based on the chip length used for D2R transmission being equal to or greater than X, the additional time offset according to application of channel coding may not be applied. Based on the chip length used for D2R transmission being less than X, the additional time offset F according to application of channel coding may be applied. For example, X may be 4.17 s, F may be 133.33 s, and F may be 32 times X.

The reader may perform R2D transmission to the device. The device may receive the R2D transmission from the reader. The device may perform D2R transmission to the reader. A time offset from an end time of the R2D transmission of the reader to a start time of the D2R transmission of the device may be defined. The time offset may be defined as a ‘sixth time offset’. The D2R transmission of the device may not be a D2R transmission required for a random access procedure. The device may perform the D2R transmission after the time offset (e.g., the sixth time offset) from the end time of the R2D transmission of the reader.

The sixth time offset may be a predefined value in the communication system. The sixth time offset may vary based on a chip length used by a device for PDRCH transmission. Based on the chip length used for PDRCH transmission being long (e.g., based on the chip length used for PDRCH transmission being equal to or greater than a threshold), the sixth time offset may be defined as a large value (e.g., a large value among a plurality of preset values). Based on the chip length used for PDRCH transmission being short (e.g., based on the chip length used for PDRCH transmission being less than a threshold), the sixth time offset may be defined as a small value (e.g., a small value among the plurality of preset values). For example, based on the chip length used for PDRCH transmission being equal to or greater than X, the sixth time offset may be defined as K. Based on the chip length used for PDRCH transmission being less than Y, the sixth time offset may be defined as M.

As another exemplary embodiment, based on a chip length used for PRDCH transmission including PDRCH scheduling information being long (e.g., based on the chip length used for PRDCH transmission including the PDRCH scheduling information being equal to or greater than a threshold), the sixth time offset may be defined as a large value (e.g., a large value among a plurality of preset values), and based on the chip length used for PRDCH transmission including the PDRCH scheduling information being short (e.g., based on the chip length used for PRDCH transmission including the PDRCH scheduling information being less than a threshold), the sixth time offset may be defined as a small value (e.g., a small value among the plurality of preset values). For example, based on the chip length used for PRDCH transmission including the PDRCH scheduling information being equal to or greater than X, the sixth time offset may be defined as K. For example, based on the chip length used for PRDCH transmission including the PDRCH scheduling information being less than Y, the sixth time offset may be defined as M.

As another exemplary embodiment, when a chip length used for PDRCH transmission is relatively long, the sixth time offset may be defined according to the chip length used for PDRCH transmission, and when the chip length used for PDRCH transmission is relatively short, the sixth time offset may be defined according to a chip length used for PRDCH transmission including PDRCH scheduling information. For example, based on the chip length used for PDRCH transmission being equal to or greater than X, the sixth time offset may be determined according to the chip length used for PDRCH transmission. For example, based on the chip length used for PDRCH transmission being equal to or greater than Y, the sixth time offset may be K. For example, based on the chip length used for PDRCH transmission being less than Z, the sixth time offset may be L. For example, based on the chip length used for PDRCH transmission being less than X, the sixth time offset may be determined according to the chip length used for PRDCH transmission including the PDRCH scheduling information. For example, based on the chip length used for PRDCH transmission including the PDRCH scheduling information being equal to or greater than W, the sixth time offset may be A. For example, based on the chip length used for PRDCH transmission including the PDRCH scheduling information being less than W, the sixth time offset may be B. For example, X may be 4.17 s, W may be 33.33 s, and W may be eight times X.

The sixth time offset may vary according to whether channel coding is applied to PDRCH in D2R transmission of the device. Based on the device applying channel coding to PDRCH (e.g., D2R transmission), the sixth time offset may be defined as a large value (e.g., a large value among a plurality of preset values). When the device applies channel coding to PDRCH, the sixth time offset may be determined by applying (e.g., adding) an additional time offset F to a time offset when the device does not apply channel coding to PDRCH. The additional time offset according to application of channel coding may be applied differently based on a payload size of D2R transmission. For example, based on the number of bits transmitted by D2R transmission being large (e.g., based on the number of bits transmitted through D2R transmission being equal to or greater than a threshold), the additional time offset according to application of channel coding may be determined as a large value (e.g., a large value among the plurality of preset values). For example, based on the number of bits transmitted by D2R transmission being small (e.g., based on the number of bits transmitted through D2R transmission being less than a threshold), the additional time offset according to application of channel coding may be determined as a small value (e.g., a small value among a plurality of preset values). Based on a number of bits or bytes transmitted by D2R transmission being equal to or less than X, the additional time offset according to application of channel coding may be K. Based on a number of bits or bytes transmitted by D2R transmission being greater than Y, the additional time offset according to application of channel coding may be M. M may be a value greater than K. X may be set in units of bits or units of bytes. K or M may be set in an absolute time unit (e.g., microseconds). For example, X may be 32 bytes, Y may be 64 bytes, and M may be two times or four times K.

One or more devices may transmit first messages. The reader may receive one or more first messages from one or more devices, and the reader may transmit second messages corresponding to respective first messages among the one or more first messages. The device may receive a second message from the reader, and the device may transmit a third message corresponding to the second message to the reader. The second messages may be transmitted by being multiplexed in the time domain. For example, a second message #1 and a second message #2 may be transmitted by using different time resources. The device that has received a second message may transmit a third message. Devices may transmit third messages by using different frequency resources in the frequency domain. As another exemplary embodiment, devices may transmit third messages by using different time resources in the time domain. For example, a device may transmit a third message #1 to the reader after receiving a second message #1. A device may transmit a third message #2 to the reader after receiving a second message #2. The reader may transmit the second message #2 to the device after receiving the third message #1. Each device may transmit a third message to the reader after receiving a second message for the device. Alternatively, the reader may transmit a second message #1 and a second message #2 by multiplexing the second message #1 and the second message #2 in the time domain. The reader may allocate different time resources for a third message #1 and a third message #2. A device may determine time resources based on information indicated by the reader, and the device may transmit the third message #1 or the third message #2 to the reader in the determined time resources.

A random access procedure of a device in a communication system is described. A reader may transmit information on a random access type to a device. The reader may transmit a random access indication including information on the random access type. The random access type may indicate CBRA or CFRA. The device may receive information on the random access type from the reader. The device may identify information on the random access type through the random access indication received from the reader. The device may perform random access based on the random access type indicated by the reader.

Based on CFRA being indicated to the device, the device may transmit a first message by using a transmission resource indicated by the reader. The device may not perform a separate contention resolution step.

Based on CBRA being indicated to the device, the device may transmit a first message by using one transmission resource among transmission resources indicated by the reader. The device may perform a contention resolution step.

In the contention resolution step, the device may transmit a first message including a device ID. When the reader successfully receives the first message from the device, the reader may transmit a second message to the device. The second message may include the device ID transmitted by the device. When the device successfully receives the second message from the reader, the device may determine that contention resolution has been successfully performed. When contention is resolved, the device may transmit a third message to the reader. When the device fails to receive the second message from the reader, the device may determine that contention resolution has not been performed. When the device fails to receive the second message within a reception duration of the second message, the device may determine that the device has failed to receive the second message.

When the reader receives the third message from the device, the reader may determine that a contention resolution step of the device has been successfully performed. When the reader fails to receive the third message from the device, the reader may determine that the contention resolution step of the device has not been successfully performed. The reader may indicate transmission of a first message to a device for which the contention resolution step has not been successfully performed. The reader may separately indicate a transmission resource for transmission of a first message to a device for which the contention resolution step has not been successfully performed. The separate transmission resource may be a transmission resource having a range narrower than a range of transmission resources available for initial first message transmission of the device (e.g., a time resource range and/or a frequency resource range).

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a device, comprising:
receiving, from a reader, a physical reader to device channel (PRDCH) including scheduling information for a first message of a random access procedure;
determining a first time resource for transmission of the first message based on an end time of the PRDCH and a first time offset; and
transmitting, to the reader, a physical device to reader channel (PDRCH) including the first message in the first time resource.

2. The method of claim 1, wherein the first time offset is determined based on a chip length used for transmission of the PDRCH.

3. The method of claim 2, wherein based on the chip length used for transmission of the PDRCH being equal to or greater than a threshold, the first time offset is determined as a large value among a plurality of values.

4. The method of claim 2, wherein based on the chip length used for transmission of the PDRCH being less than a threshold, the first time offset is determined as a small value among a plurality of values.

5. The method of claim 1, wherein the first time offset is determined based on a chip length used for transmission of the PRDCH including the scheduling information for the first message.

6. The method of claim 5, wherein based on the chip length used for transmission of the PRDCH being equal to or greater than a threshold, the first time offset is determined as a large value among a plurality of values.

7. The method of claim 5, wherein based on the chip length used for transmission of the PRDCH being less than a threshold, the first time offset is determined as a small value among a plurality of values.

8. The method of claim 1, wherein the PRDCH is a random access indication indicating initiation of the random access procedure.

9. A method of a device, comprising:
receiving, from a reader, a physical reader to device channel (PRDCH) including scheduling information for a first message of a random access procedure;
determining, based on an end time of the PRDCH and a second time offset, a second time resource after a first time resource among a plurality of resources for transmission of the first message; and
transmitting, to the reader, a second physical device to reader channel (PDRCH) including the first message in the second time resource.

10. The method of claim 9, wherein the second time offset is determined based on a first time offset used to determine the first time resource and a length of a first PDRCH transmitted in the first time resource.

11. The method of claim 10, wherein the second time offset is determined by multiplying a sum of the first time offset and the length of the first PDRCH with a constant value including a length of a time buffer.

12. The method of claim 10, wherein the length of the first PDRCH transmitted in the first time resource is determined based on a product of a number of chips transmitted through the first PDRCH and a chip length used for transmission of the first PDRCH.

13. The method of claim 10, wherein the PRDCH is a random access indication indicating initiation of the random access procedure.

14. A device comprising at least one processor, wherein the at least one processor causes the device to perform:
receiving, from a reader, a physical reader to device channel (PRDCH) including scheduling information for a first message of a random access procedure;
determining a first time resource for transmission of the first message based on an end time of the PRDCH and a first time offset; and
transmitting, to the reader, a physical device to reader channel (PDRCH) including the first message in the first time resource.

15. The device of claim 14, wherein the first time offset is determined based on a chip length used for transmission of the PDRCH.

16. The device of claim 15, wherein based on the chip length used for transmission of the PDRCH being equal to or greater than a threshold, the first time offset is determined as a large value among a plurality of values.

17. The device of claim 15, wherein based on the chip length used for transmission of the PDRCH being less than a threshold, the first time offset is determined as a small value among a plurality of values.

18. The device of claim 14, wherein the first time offset is determined based on a chip length used for transmission of the PRDCH including the scheduling information for the first message.

19. The device of claim 18, wherein based on the chip length used for transmission of the PRDCH being equal to or greater than a threshold, the first time offset is determined as a large value among a plurality of values.

20. The device of claim 18, wherein based on the chip length used for transmission of the PRDCH being less than a threshold, the first time offset is determined as a small value among a plurality of values.
